(19) United States
(12) Patent Application Publication
(10) Pub. No.: US 2010/0090928 A1
(43) Pub. Date: Apr. 15, 2010

(54) Liquid Craystal Display Device, its Driving Method and Electronic Device

(76) Inventors: Yasutoshi Maeda, Nara (JP); Naoshi Yamada, Mie (JP)

Correspondence Address: HARNESS, DICKEY & PIERCE, P.L.C., P.O. BOX 8910, RESTON, VA, 20195, US

(21) Appl. No.: 12/225,247

(22) PCT Filed: Dec. 5, 2006
(86) PCT No.: PCT/JP2006/324269

§ 371 Date: Sep. 17, 2008

(30) Foreign Application Priority Data
Apr. 28, 2006 (JP) 2006-127048

(51) Int. Cl. G09G 5/00; G02F 1/1347

(52) U.S. Cl. 345/4; 349/74

(57) ABSTRACT

In one embodiment of the present invention, a method for driving a liquid crystal display device is disclosed which includes: combining liquid crystal panels a and b with one another, each of which displays an image in accordance with a video image source, wherein, when the images respectively displayed on the liquid crystal panels are combined with one another so that a signal image is displayed, the images that are different from each other are switched with one another at a preset interval. As a result, a phosphor burn-in on a display screen is difficult to occur, even when an identical image is displayed continuously for an extended period of time.

### TECHNICAL FIELD

The present invention relates to a liquid crystal display device in which at least two liquid crystal panels are combined with one another, and to a method for driving the liquid crystal display device.

### BACKGROUND ART

In general, phosphor burn-ins on a display screen are less likely to occur in liquid crystal display panels than in cathode-ray tube (CRT) display panels.

However, even in a case of causing a liquid crystal display panel to continuously display an identical image for an extended period of time, it is likely that a phosphor burn-in on a display screen occurs in the liquid crystal display panel.

Conventionally, in a case of continuously displaying an identical image on a liquid crystal display panel, such a display has been stopped regularly so that a phosphor burn-in on a display screen is prevented from occurring.

No problem occurs when a display may be stopped regularly. Meanwhile, some problems occur when a display is stopped regularly in a liquid crystal display panel, such as a display for displaying a train timetable, in which it is necessary to continuously display an identical image for an extended period of time.

Patent Document 1 discloses an art for preventing phosphor burn-ins on a display screen without stopping a display.

According to a liquid crystal display device of Patent Document 1, phosphor burn-ins are prevented by reversing a polarity of a pixel voltage for every field or for every positive integral multiple of the field.

[Patent Document 1] Japanese Unexamined Patent Application Publication No. 253231/1990 (Tokukaihei 2-253231; published on Oct. 12, 1990)

### DISCLOSURE OF INVENTION

According to Patent Document 1, however, a display is continuously carried out while a polarity of a pixel voltage is reversed for every field or for every positive integral multiple of the field, without stopping a display on a liquid crystal display panel. It follows that a display voltage is continuously applied to the liquid crystal display panel.

Such a continuous, prolonged application of the display voltage (liquid crystal driving voltage) to the liquid crystal display panel causes the liquid crystal driving voltage to easily have a certain DC component. This causes an electric charge to be accumulated in the liquid crystal display panel. Consequently, even when the application of the driving voltage to the liquid crystal display panel is stopped, the electric charge thus accumulated causes a residual image. In other words, even when the driving voltage to be applied is changed so that another image is displayed, a previous image remains visible due to the phosphor burn-in.

The present invention addresses the problem discussed above, and aims to provide a liquid crystal display device in which a phosphor burn-in on a display screen is difficult to occur, even in a case of continuously displaying an identical image for an extended period of time.

In order to solve the above problem, a method for driving a liquid crystal display device in accordance with the present invention includes: when at least two liquid crystal panels, which are combined with one another, display respective images which vary in accordance with a video image source so that an image corresponding to the video image source is displayed by the at least two liquid crystal panels, replacing the respective images, displayed on the at least two liquid crystal panels, with one another at a preset interval.

According to the above arrangement, when the respective images which vary in accordance with the video image source are displayed on the liquid crystal panels that are combined with one another, the respective images displayed on the liquid crystal panels are switched at a preset interval. Therefore, it is possible to prevent a single liquid crystal panel from continuously displaying an identical image.

Consequently, it is possible to prevent phosphor burn-ins that occur when an identical image is continuously displayed on a single liquid crystal panel.

Thus, it is possible to suppress a decrease in display quality caused by phosphor burn-ins of the liquid crystal panels, and to continuously display an identical image for an extended period of time, by the liquid crystal display device as a whole is thereby capable of, without causing a decrease in display quality.

In order to solve the above problem, a liquid crystal display device of the present invention in which at least two liquid crystal panels, which are combined with one another, display respective images which vary in accordance with a video image source so that an image corresponding to the video image source is displayed by the at least two liquid crystal panels, the liquid crystal display device including: display signal generating means for generating display signals causing the at least two liquid crystal panels to display the respective images that are different from one another in accordance with the video image source; and display signal outputting means for switching the display signals, generated by the display signal generating means, with one another for every preset period of time, and for outputting the display signals thus switched to the at least two liquid crystal panels, respectively.

According to the above arrangement, the display signal outputting means performs a control so that the display signals, generated by the display signal generating means, are switched with one another for every preset period of time, and outputted to the liquid crystal panels, respectively. Therefore, it is possible to prevent a single liquid crystal panel from continuously displaying an identical image.

Consequently, it is possible to prevent phosphor burn-ins that occur when an identical image is continuously displayed on a single liquid crystal panel.

Thus, it is possible to suppress a decrease in display quality caused by phosphor burn-ins of the liquid crystal panels, and to continuously display an identical image for an extended period of time, by the liquid crystal display device as a whole, without causing a decrease in display quality.

In the above arrangement, all of the respective images displayed on the liquid crystal panels may be caused to be different from one another, or two of the respective images may be caused to be different. For example, in a case of combining three liquid crystal panels, it is possible to cause the three liquid crystal panels to display respective images that are different from one another, and to switch the respective images displayed on the liquid crystal panels with one another at a preset interval. Alternatively, it is possible to cause two of the three liquid crystal panels to display respective images that are different from each other, to cause another remaining liquid crystal panel to display an image identical with one of the above images, and to switch the respective images displayed on the liquid crystal panels with one another at a preset interval.

In order to solve the above problem, a liquid crystal display device of the present invention in which at least two liquid crystal panels, which are combined with one another, display respective images which vary in accordance with a video image source so that an image corresponding to the video image source is displayed by the at least two liquid crystal panels, the liquid crystal display device, including display signal generating means for generating display signals causing some of the at least two liquid crystal panels to display images in accordance with the video image source; display signal outputting means for switching the display signals for every preset period of time, and for outputting the display signals thus switched to ones of the at least two liquid crystal panels except at least one of the at least two liquid crystal panels; and voltage application controlling means for controlling driving voltages to be respectively applied to the at least two liquid crystal panels, the voltage application controlling means stopping applying of driving voltages to the at least one of the at least two liquid crystal panels to each of which no display signal is supplied by the display signal outputting means.

According to the above arrangement, by stopping applying of the driving voltages to at least one of the at least two liquid crystal panels to each of which no display signal is supplied by the display signal outputting means, it is possible to completely stop applying of the voltages to the liquid crystal panel that is not displaying the image corresponding to the video image source.

As a result, it is less likely that an electric charge caused by the application of the voltage is accumulated in the liquid crystal panels, and thereby it is possible to eliminate a residual image on the liquid crystal panels caused by the accumulation of an electric charge.

In addition, no voltage is applied to at least one of the liquid crystal panels. Therefore, power consumption can be reduced.

The liquid crystal display device may be arranged such that the at least two liquid crystal panels consists of first and second liquid crystal panels, and the display signal generating means generates, in accordance with the video image source, display signals that cause (i) the first liquid crystal panel to carry out a display of the image corresponding to the video image source, and (ii) the second liquid crystal panel to carry out a display that does not affect the display carried out by the first liquid crystal panel.

According to the above arrangement, the display signal generating means generates, in accordance with the video image source, display signals that cause (i) the first liquid crystal panel to carry out a display of the image corresponding to the video image source, and (ii) the second two liquid crystal panel to carry out a display that does not affect the display of the first liquid crystal panel. Consequently, there constantly exist: a liquid crystal panel that carries out a display of the image corresponding to a video image source; and a liquid crystal panel that carries out a display that does not affect the above display.

As a result, one of the liquid crystal panels can be in a refreshment state and therefore accumulation of an electric charge that causes a phosphor burn-in does not occur.

The liquid crystal display device may preferably be arranged such that the display signals are ones causing (i) the first liquid crystal panel to carry out a display of the image corresponding to the video image source, and (ii) the second liquid crystal panel to carry out a display so that the second liquid crystal panel entirely becomes a light transmittance state, in accordance with the video image source.

In a case where liquid crystal of the liquid crystal panels transmits light when no voltage is applied, it is possible to refresh the liquid crystal panels without application of a voltage. For example, display signals are generated that cause a voltage for a whitish tone or no voltage to be applied to a liquid crystal panel to be refreshed. In a case where the liquid crystal of the liquid crystal panels transmits light when a voltage is applied, the liquid crystal panel is refreshed with application of a voltage. Since, in this case, the voltage is uniformly applied to the liquid crystal panel, phosphor burn-ins can be prevented. Consequently, regardless of the type of the liquid crystal panels, while the liquid crystal panel is carrying out a white display (i.e. optically transparent state), such a display does not have relation to the display image corresponding to the video image source. As a result, the liquid crystal panel is in the refreshment state.

Specifically, the refreshment of the liquid crystal panel refers either to prevention of accumulation of an electric charge caused by a DC component that is accumulated due to application of the driving voltage, or to discharge of such an electric charge accumulated.

Consequently, it is possible to prevent phosphor burn-ins that occur when an identical image is continuously displayed on a single liquid crystal panel.

Furthermore, when the liquid crystal panel is optically transparent without application of the voltage, it is possible to reduce a decrease in quality of the liquid crystal in the liquid crystal panel in the refreshment state, dots, source lines, and gate lines, which decrease is caused by the application of the voltage. Therefore, it is possible to prevent phosphor burn-ins on a display screen for a further extended period of time.

The liquid crystal display device may be arranged such that the display signal generating means generates display signals that cause the at least two liquid crystal panels to display images that are different for every dot so that the image corresponding to the video image source is displayed by the at least two liquid crystal panels which are combined with one another.

According to the above arrangement, since the respective images displayed on the liquid crystal panels are different for every dot, dots that do not have relation to the display image corresponding to the video image source can be in the refreshment state, i.e., in a white display state.

In consequence, in a case where a display according to a video image source is continuously carried out for an extended period of time, there are always some dots of the liquid crystal panels which dots are in the refreshment state. Therefore, phosphor burn-ins on a display screen can be prevented.

The liquid crystal display device may be arranged such that the display signal generating means generates display signals that cause the at least two liquid crystal panels to display images that are different for every source line so that the image corresponding to the video image source is displayed by the at least two liquid crystal panels which are combined with one another.

According to the above arrangement, since the respective images displayed on the liquid crystal panels are different for every source line, source lines that do not have relation to the display image corresponding to the video image source can be in the refreshment state, i.e., in the white display state.

In consequence, in a case where a display according to a video image source is continuously carried out for an extended period of time, there are always some source lines of the liquid crystal panels which source lines are in the refreshment state. Therefore, phosphor burn-ins on a display screen can be prevented.

The liquid crystal display device may be arranged such that the display signal generating means generates display signals that cause the at least two liquid crystal panels to display images that are different for every gate line so that the image corresponding to the video image source is displayed by the at least two liquid crystal panels which are combined with one another.

According to the above arrangement, since the respective images displayed on the liquid crystal panels are different for every gate line, gate lines that do not have relation to the display image corresponding to the video image source can be in the refreshment state, i.e., in the white display state.

In consequence, in a case where a display according to a video image source is continuously carried out for an extended period of time, there are always some gate lines of the liquid crystal panels which gate lines are in the refreshment state. Therefore, phosphor burn-ins on a display screen can be prevented.

The liquid crystal display device may preferably further include a timer for measuring time, the preset period of time being a period of time measured by the timer.

In this case, it is possible to easily switch where the display signals are supplied to. For example, when a set time of the timer is for daytime (from 6 am to 6 pm), at least one of the liquid crystal panels is caused to display an image, and driving of a remaining liquid crystal panel can be stopped during that time.

As a result, power consumed of the liquid crystal display device as a whole can be effectively reduced.

The liquid crystal display device may preferably be arranged such that the preset interval is a frame period of the at least two liquid crystal panels.

As above, when the preset interval is the frame period of the liquid crystal panels, it is unnecessary to generate an extra timing clock for switching the images to be displayed. Consequently, it is possible to realize display control means with use of an existing liquid crystal driving circuit.

As a result, it is possible to inexpensively provide a liquid crystal display device in which it is possible to suppress a decrease in display quality caused by phosphor burn-ins of the liquid crystal panels, and, as a whole, to continuously display an identical image for an extended period of time, without causing a decrease in display quality.

The frame period of the liquid crystal panels may be one frame period, or to at least two frame periods. Alternatively, it may be half a frame period. In this case, although it is required to change the timing clock and add a frame memory, it is possible to reduce flicker that occurs when images on a display screen are switched.

The liquid crystal display device may be arranged such that polarizing absorption layers, by which the at least two liquid crystal panels are sandwiched, respectively, are provided so that crossed Nichol relations are formed.

In this case, from a frontal viewing angle, it is possible to block light that leaks in a transmission axis direction of a polarizing absorption layer, by an absorption axis of a next polarizing absorption layer. Further, from an oblique viewing angle, even if a Nichol angle, which is formed by intersection of polarization axes of adjacent polarizing absorption layers, is deformed, an increase in an amount of light caused by a light leak is not observed. In other words, a defective black display is less likely to occur with respect to widening of the Nichol angle from an oblique viewing angle.

As described above, when at least two liquid crystal panels are combined with one another and polarizing absorption layers are provided so as to form crossed Nichol relations via the liquid crystal panels, there are at least three of the polarizing absorption layers provided. When the three polarizing absorption layers forming crossed Nichol relations with one another, it is possible to significantly improve a light shutting property with regard to both a frontal viewing angle and an oblique viewing angle. Consequently, contrast can be improved significantly.

As a result, it is possible to provide a liquid crystal display device in which contrast is improved and phosphor burn-ins on a display screen can be prevented.

The liquid crystal display device may be arranged such that two polarizing absorption layers are provided on an uppermost surface and on a lowermost surface of the at least two liquid crystal panels, respectively, which are combined with one another, and polarizing axes of the polarizing absorption layers are set so that the polarizing absorption layers form a crossed Nichol relation.

In this case, two polarizing absorption layers are provided. Thus, it is possible to improve luminance, in comparison with the case where the polarizing absorption layers are provided so as to sandwich each of the liquid crystal panels. Further, since the number of the polarizing absorption layers is small, it is possible to reduce a price of the liquid crystal display device.

An electronic device of the present invention may include the liquid crystal display device having the above arrangement.

Examples of the electronic device that includes the liquid crystal display device having the above arrangement include electronic devices that need to continuously display an identical image for an extended period of time, such as portable terminal devices including portable phones, traffic signs, train timetables, electronic advertisements, ATMs, information displays, direction boards, message boards, measuring devices, and operation panels.

With use of the electronic device above, it is possible to display a high-quality image with few phosphor burn-ins.

### BRIEF DESCRIPTION OF DRAWINGS

FIG. 1(a) is a schematic view of how a liquid crystal display device is driven in accordance with an embodiment of the present invention.

FIG. 1(b) is a schematic view of how the liquid crystal display device is driven in accordance with an embodiment of the present invention.

FIG. 2 is a schematic view of an arrangement of a liquid crystal display device, in accordance with an embodiment of the present invention.

FIG. 3(a) is a schematic cross-sectional view of a pixel, for explanation of MVA liquid crystal.

FIG. 3(b) is a schematic cross-sectional view of the pixel, for explanation of the MVA liquid crystal.

FIG. 4 is a block diagram schematically illustrating the arrangement of the liquid crystal display device.

FIG. 5 shows a state in which no voltage is applied to liquid crystal panels that are normally black when they are used individually.

FIG. 6 is an explanatory diagram illustrating a switch of display states of the liquid crystal panels of FIG. 5 that are normally black when they are used individually.

FIG. 7(a) is a schematic cross-sectional view of a pixel, for explanation of PVA liquid crystal.

FIG. 7(b) is a schematic cross-sectional view of the pixel, for explanation of the PVA liquid crystal.

FIG. 8(a) is a schematic cross-sectional view of a pixel, for explanation of IPS liquid crystal.

FIG. 8(b) is a schematic cross-sectional view of the pixel, for explanation of the IPS liquid crystal.

FIG. 8(c) is a schematic cross-sectional view of the pixel, for explanation of the IPS liquid crystal.

FIG. 8(d) is a schematic cross-sectional view of the pixel, for explanation of the IPS liquid crystal.

FIG. 9(a) is a schematic cross-sectional view of a pixel, for explanation of TN liquid crystal.

FIG. 9(b) is a schematic cross-sectional view of the pixel, for explanation of the TN liquid crystal.

FIG. 10 shows a state in which no voltage is applied to liquid crystal panels that are normally white when they are used individually.

FIG. 11 is an explanatory diagram illustrating a switch of display states of the liquid crystal panels of FIG. 10 that are normally white when they are used individually.

FIG. 12 is a diagram illustrating an example of a composite display image.

FIG. 13 is a diagram illustrating voltage setting screens of liquid crystal panels a and b for a first frame.

FIG. 14 is a timing chart showing timing of application of voltages to pixel electrodes of the liquid crystal panels a and b for the first frame.

FIG. 15 is a diagram illustrating voltage setting screens of the liquid crystal panels a and b for a second frame.

FIG. 16 is a timing chart showing timing of application of the voltages to the pixel electrodes of the liquid crystal panels a and b for the second frame.

FIG. 17 is a diagram illustrating voltage setting screens of the liquid crystal panels a and b for a third frame.

FIG. 18 is a timing chart showing timing of application of the voltages to the pixel electrodes of the liquid crystal panels a and b for the third frame.

FIG. 19 is a schematic view of another driving method of the liquid crystal display device, in accordance with an embodiment of the present invention.

FIG. 20 is a diagram illustrating another example of a composite display image.

FIG. 21 is a diagram illustrating voltage setting screens of the liquid crystal panels a and b for a first frame.

FIG. 22 is a timing chart showing timing of application of voltages to pixel electrodes of the liquid crystal panels a and b for the first frame.

FIG. 23 is a diagram illustrating voltage setting screens of the liquid crystal panels a and b for a second frame.

FIG. 24 is a timing chart showing timing of application of the voltages to the pixel electrodes of the liquid crystal panels a and b for the second frame.

FIG. 25 is a diagram illustrating voltage setting screens of the liquid crystal panels a and b for a third frame.

FIG. 26 is a timing chart showing timing of application of the voltages to the pixel electrodes of the liquid crystal panels a and b for the third frame.

FIG. 27 is a diagram illustrating still another example of a composite display image.

FIG. 28 is a diagram illustrating voltage setting screens of the liquid crystal panels a and b for a first frame.

FIG. 29 is a timing chart showing timing of application of voltages to the pixel electrodes of the liquid crystal panels a and b for the first frame.

FIG. 30 is a diagram illustrating voltage setting screens of the liquid crystal panels a and b for a second frame.

FIG. 31 is a timing chart showing timing of application of the voltages to the pixel electrodes of the liquid crystal panels a and b for the second frame.

FIG. 32 is a diagram illustrating voltage setting screens of the liquid crystal panels a and b for a third frame.

FIG. 33 is a timing chart showing timing of application of the voltages to the pixel electrodes of the liquid crystal panels a and b for the third frame.

FIG. 34 is a diagram illustrating still another example of a composite display image

FIG. 35 is a diagram illustrating voltage setting screens of the liquid crystal panels a and b for a first frame.

FIG. 36 is a timing chart showing timing of application of voltages to the pixel electrodes of the liquid crystal panels a and b for the first frame.

FIG. 37 is a diagram illustrating voltage setting screens of the liquid crystal panels a and b for a second frame.

FIG. 38 is a timing chart showing timing of application of the voltages to the pixel electrodes of the liquid crystal panels a and b for the second frame.

FIG. 39 is a diagram illustrating voltage setting screens of the liquid crystal panels a and b for a third frame.

FIG. 40 is a timing chart showing timing of application of the voltages to the pixel electrodes of the liquid crystal panels a and b for the third frame.

FIG. 41 is a diagram illustrating still another example of a composite display image.

FIG. 42 is a diagram illustrating voltage setting screens of the liquid crystal panels a and b for a first frame.

FIG. 43 is a timing chart showing timing of application of voltages to the pixel electrodes of the liquid crystal panels a and b for the first frame.

FIG. 44 is a diagram illustrating voltage setting screens of the liquid crystal panels a and b for a second frame.

FIG. 45 is a timing chart showing timing of application of the voltages to the pixel electrodes of the liquid crystal panels a and b for the second frame.

FIG. 46 is a diagram illustrating voltage setting screens of the liquid crystal panels a and b for a third frame.

FIG. 47 is a timing chart showing timing of application of the voltages to the pixel electrodes of the liquid crystal panels a and b for the third frame.

FIG. 48 is a schematic cross-sectional view of a liquid crystal display device in accordance with another embodiment of the present invention.

FIG. 49 shows a state in which no voltage is applied to liquid crystal panels that are normally black when they are used individually.

FIG. 50 is an explanatory diagram illustrating a switch of display states of the liquid crystal panels of FIG. 49 that are normally black when they are used individually.

FIG. 51 shows a state in which no voltage is applied to liquid crystal panels that are normally white when they are used individually.

FIG. 52 is an explanatory diagram illustrating a switch of display states of the liquid crystal panels of FIG. 51 that are normally white when they are used individually.

FIG. 53 is an explanatory diagram illustrating another switch of display states of the liquid crystal panels of FIG. 51 that are normally white when they are used individually.

### BEST MODE FOR CARRYING OUT THE INVENTION

### Embodiment 1

One embodiment of the present invention is described below.

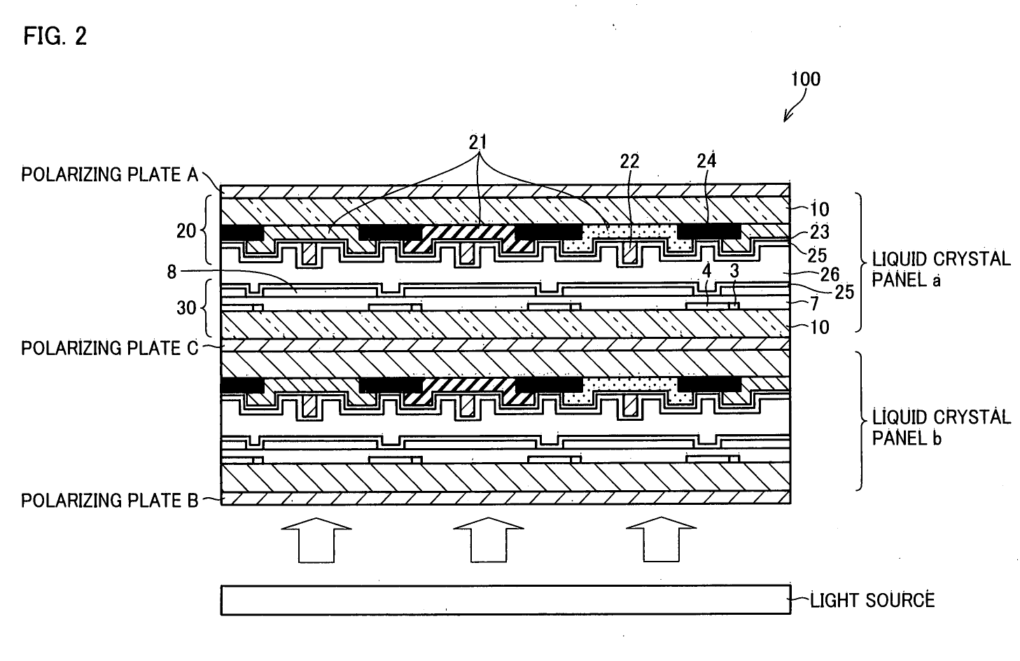

FIG. 2 is a schematic cross-sectional view of a liquid crystal display device 100 of the present embodiment.

As shown in FIG. 2, the liquid crystal display device 100 is arranged so that liquid crystal panels a and b are combined with each other, a polarizing plate A is attached to an upper surface of the liquid crystal panel a, a polarizing plate B is attached to a lower surface of the liquid crystal panel b, and a polarizing plate C is attached to and sandwiched by the liquid crystal panels a and b. It is preferable to provide a light diffusion sheet, either between the liquid crystal panels a and b or on a side of the liquid crystal panel a, from which side a viewer views the liquid crystal panel a. This is because interference of pixels in the liquid crystal panels a and b may cause a moire image.

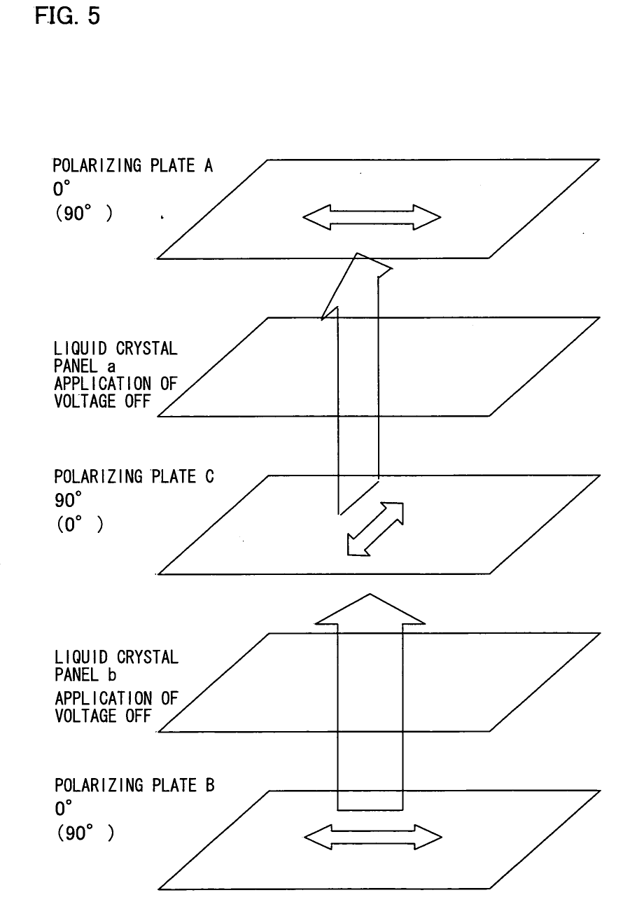

As illustrated, for example, in FIG. 5, the polarizing plates A, B, and C in the above arrangement are provided so as to have crossed Nichol relations, respectively, via the liquid crystal panels.

Each of the liquid crystal panels a and b is arranged so that a liquid crystal is sealed between a pair of transparent substrates (a color filter substrate 20 and an active matrix substrate 30). Means is provided for electrically changing an alignment of the liquid crystal so as to arbitrarily change polarized light, entered from a light source to the polarizing plate, into one of (i) a state in which the polarized light is skewed by approximately 90 degrees, (ii) a state in which the polarized light is not rotated, and (iii) an intermediate state between the states (i) and (ii).

Each of the liquid crystal panels a and b includes a color filter and has a function of displaying an image with use of multiple pixels. Display modes involving such a function are exemplified by a Twisted Nematic (TN) mode, a Vertical Alignment (VA) mode, an In Plain Switching (IPS) mode, a Fringe Field Switching (FFS) mode, and a combination of the modes.

Described first is a Multi-domain Vertical Alignment (MVA) mode which is a type of the VA mode.

An active matrix driving with the use of a thin film transistor (TFT) is adopted for driving the liquid crystal panels a and b.

The liquid crystal panels a and b have a same structure. As described above, each of them includes the color filter substrate 20 and the active matrix substrate 30 that face each other. The liquid crystal panels a and b are arranged so as to maintain a fixed space between the liquid crystal panels a and b by using a spacer (not shown) such as a plastic bead and/or a columnar resin structure that is provided on the color filter substrate 20. The liquid crystal 26 is sealed between the pair of the substrates (the color filter substrate 20 and the active matrix substrate 30). A vertical alignment film 25 is provided between the liquid crystal 26 and a respective of the substrates. A nematic liquid crystal having a negative dielectric anisotropy is used as the liquid crystal 26.

The color filter 20 is arranged so that a color filter 21, a black matrix 24, a common electrode 23, an alignment control projection 22, and the like are provided on a transparent substrate 10.

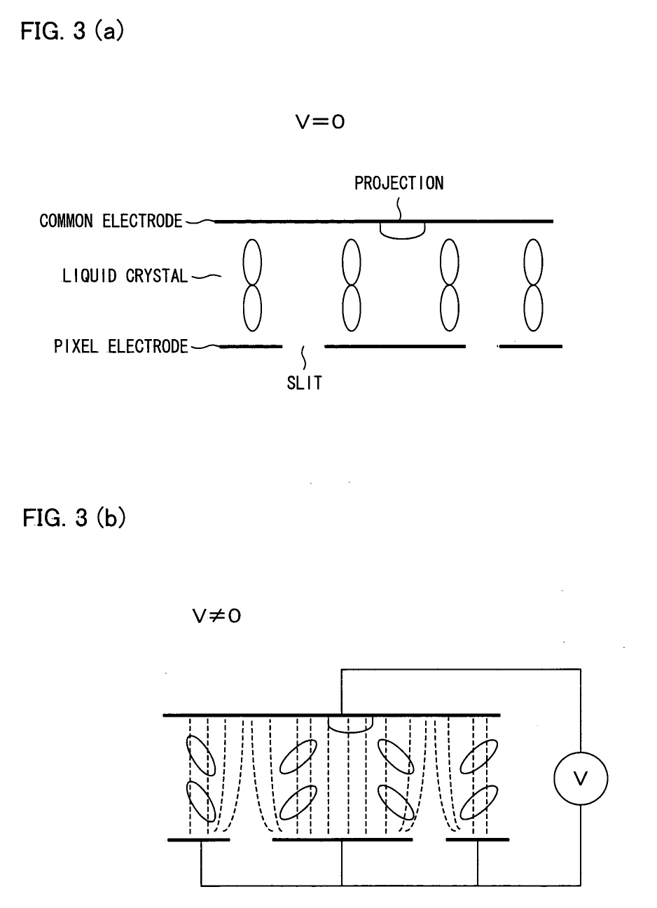

The active matrix substrate 30 is arranged so that a TFT element 3, a data signal wiring 4, an insulating interlayer 7, a pixel electrode 8, and the like are provided on a transparent substrate 10. The active matrix substrate 30 further includes a slit (not shown), which serves as an opening in the pixel electrode, for defining an alignment direction of the liquid crystal 26. When a voltage of not less than a threshold value is applied to the pixel electrode 8, liquid crystal molecules align vertically to the projection 22 and the slit. FIGS. 3(a) and 3(b) are schematic cross-sectional views of a pixel, explanation of an MVA mode. FIG. 3(a) shows that the liquid crystal molecules lie vertically when no voltage is applied. FIG. 3(b) shows that the liquid crystal molecules are slanted around border, defined by projections formed on the common electrode and the opening, i.e., the slit formed in the pixel electrode, when a non-zero voltage is applied (to be precise, when a voltage of not less than a threshold voltage is applied). Dotted lines in FIG. 3(b) indicate lines of electric force generated when a voltage is applied. The liquid crystal molecules are slanted at an angle of 45 degrees or −45 degrees with respect to a transmission axis of each of the polarizing plates on both sides.

As described above, the liquid crystal panels a and b are arranged so that pixels R, G, and B of the color filters 21 overlap each other, respectively, when they are viewed from an angle vertical to the transparent substrates. Specifically, the liquid crystal panels a and b are arranged so that (i) the pixel R of the liquid crystal panel a and the pixel R of the liquid crystal panel b overlap each other; (ii) the pixel G of the liquid crystal panel a and the pixel G of the liquid crystal panel b overlap each other; and (iii) the pixel B of the liquid crystal panel a and the pixel B of the liquid crystal panel b overlap each other, when they are viewed from an angle vertical to the transparent substrates.

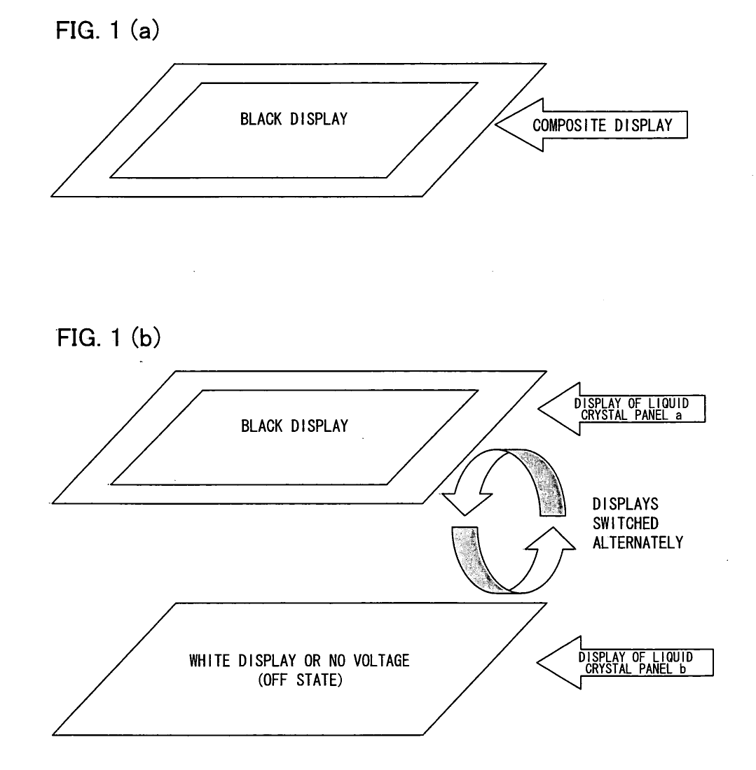

The liquid crystal display device 100 is arranged so as to display an image corresponding to a video image source by combining (i) a display image of the liquid crystal panel a with (ii) a display image of the liquid crystal panel b. For example, as shown in FIG. 1(a), when a display image (hereinafter referred to as a composite image) corresponding to a video image source is a black display, as shown in FIG. 1(b), it is assumed that the liquid crystal panel a is a black display, identical with the composite image, and the liquid crystal panel b is a white display.

Specifically, (i) if a voltage is applied to the liquid crystal panel a so that a black display is carried out by a combination of the liquid crystal panel a and the polarizing plates A and C which are regarded as forming one display device, and (ii) if a voltage is applied to the liquid crystal panel b so that a white display is carried out by a combination of the liquid crystal panel b and the polarizing plates B and C which are regarded as another display device, then their composite image will become a black display. In a case where a display image corresponding to a video image source is a given image, (i) if a signal according to the display image is supplied to the liquid crystal panel a, which is regarded as one display device in combination with the polarizing plates A and C, and if (ii) a voltage is applied to the liquid crystal panel b so that a white display is carried out by combination of the liquid crystal panel b and the polarizing plates B and C, which are regarded as another display device, then their composite image will be an image corresponding to the video image source.

According to the present embodiment, display states of the liquid crystal panels a and b are alternately switched at a preset interval so that a display control is carried out in which one of the liquid crystal panels always displays an image identical with a composite image whereas the other liquid crystal panel always carries out a white display. Thus, a display is carried out while the display states of the liquid crystal panels are switched. It follows that the liquid crystal panel that carries out a white display carries out a display that does not have relation to a display image corresponding to a video image source. This is referred to as a refreshment state of the liquid crystal panel. The display states of the liquid crystal panels may be switched at a timing which is not limited to a specific one. For example, the switching of the display states may be carried out for every frame, for every several frames, or for every half a frame. In these cases, it is required to change the timing clock and add a frame memory but it is possible to reduce flicker in screen that occurs during switching the display states. What is important is that one of the liquid crystal panels is refreshed while the other one carries out a target display. Therefore, the timing at which the display states are switched is not limited to a specific one, provided it should allow one of the liquid crystal panels to be refreshed.

Alternatively, a single image may be displayed as a composite display image, by causing one of the liquid crystal panels to display an image that is different from the other and then combining the images of both of the liquid crystal panels. In this case, unlike a case in which one of the liquid crystal panels is refreshed, different regions in both of the liquid crystal panels are refreshed simultaneously. This is because each of the liquid crystal panels is caused to constantly have a region that does not have relation to displaying of the image. Embodiment 2 below deals with this in detail.

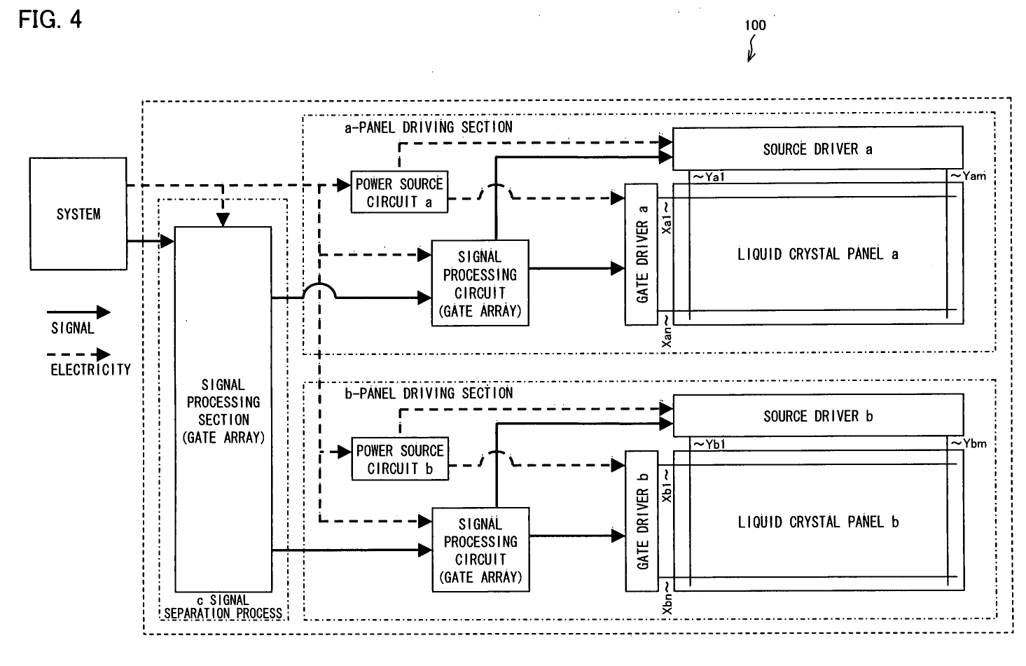

In order to perform such a display control, as shown in FIG. 4, the liquid crystal display device 100 includes: a system (display signal generating means) for generating display data for each of the liquid crystal panels and controlling an entire device; a signal processing section (display signal outputting means) for processing the display data supplied from the system so that the display data is separated for each of the liquid crystal panels; an a-panel driving section (voltage application controlling means) for driving the liquid crystal panel a; and a b-panel driving section (voltage application controlling means) for driving the liquid crystal panel b.

The liquid crystal display device 100 is arranged so that the liquid crystal panels a and b are combined with one another and each of them displays an image according to a video image source.

The signal processing section is arranged so as to (i) generate, in accordance with the video image source, display signals for causing at least two liquid crystal panels to display images that are different from one another and (ii) transmit the display signals thus generated to the a-panel driving section and the b-panel driving section, respectively.

Each of the a-panel driving section and the b-panel driving section is arranged so as to perform a driving control of transmitting a display signal, generated by the signal processing section, to a respective one of the liquid crystal panels, the display signal being switched and outputted at a preset interval.

The a-panel driving section and the b-panel driving section have an identical arrangement. Thus, the following description deals only with the a-panel driving section. It is assumed that each of the liquid crystal panels a and b has n-number of gate electrodes and m-number of source electrodes.

The a-panel driving section is arranged so as to include: a gate driver a for applying a gate voltage to the gate electrodes Xa1 through Xan; a source driver a for applying a source voltage to the source electrodes Ya1 through Yam; a signal processing circuit a for supplying the display data signals respectively to the drivers; and a power source circuit a for supplying electric power to each of the drivers.

The power source circuit a and the signal processing circuit a are arranged so as to receive electric power and a control signal from the system.

Note that the signal processing section may be provided on a side of the display panel (see FIG. 4) or on a side of the system. The signal processing section may also be designed to be incorporated in each of the signal processing circuits a and b of the panel driving sections.

The following description deals with how, in the liquid crystal display device 100 having the above arrangement, the display states are switched in a case where the liquid crystal display is in a normally black (NB) mode, and in a case where the liquid crystal display is in a normally white (NW) mode, respectively. Note that the liquid crystal display modes are the ones corresponding to a case where a liquid crystal panel and a pair of polarizing plates by which the liquid crystal panel is sandwiched are combined so as to be taken as an individual display element. The term “normally black (NB)” refers to a state in which an individual liquid crystal panel sandwiched by a pair of polarizing plates carries out a black display while no voltage is applied. Conversely, the term “normally white (NW)” refers to a state in which an individual liquid crystal panel sandwiched by a pair of the polarizing plates carries out a white display while no voltage is applied. In this embodiment, a display of an individual liquid crystal display panel in which a single liquid crystal panel and a pair of polarizing plates by which the single liquid crystal panel is sandwiched are combined is referred to simply as a display of the liquid crystal panel.

Described first is a case where a panel is used in which an individual combination of a liquid crystal panel and a pair of polarizing plates by which the liquid crystal panel is sandwiched carries out a normally black (NB) display.

FIG. 5 shows a state in which no voltage is applied to each of the liquid crystal panels, adopting a liquid crystal such as a VA liquid crystal, that carries out a NB display. In a case where each of the liquid crystal panels carries out a NB display, while no voltage is applied, the liquid crystal panels a and b are arranged so that incident light is sent out without being skewed.

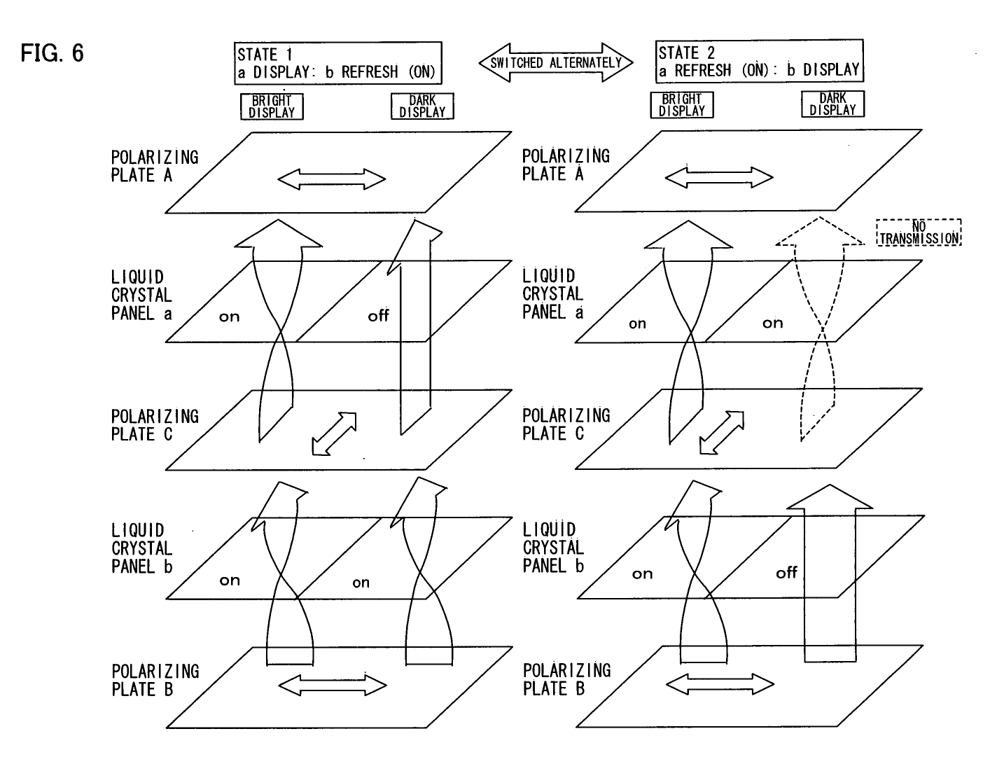

FIG. 6 is an explanatory diagram illustrating a switching of the display states obtained in the case of the NB display as shown in FIG. 5. FIG. 6 shows, for convenience of explanation, a case in which an image, combined by display images of the liquid crystal panels a and b, is a black-and-white image which has divided bright and dark display regions.

In state 1 shown in FIG. 6, one of two display regions of the liquid crystal panel a is set in an ON state in which a voltage is applied to pixel electrodes corresponding to one of the two display regions so that a polarization direction is rotated by about 90 degrees due to an electro-optic effect of the liquid crystal, whereas the other of the two display regions is set in an OFF state in which a voltage is applied to pixel electrodes corresponding to the other one of the two display regions so that a polarization direction is not rotated due to no electro-optic effect of the liquid crystal. The OFF state includes the case in which no voltage is applied to the pixel electrodes and a case where a voltage, which is inadequate to cause an alignment of the liquid crystal to be changed, is applied to the pixel electrodes.

In the following description, the OFF state refers to the case in which no voltage is applied and the state in which a voltage, which is inadequate to cause an alignment of the liquid crystal to be changed, unless otherwise indicated. It is assumed that, regarding the liquid crystal panel b, a voltage is applied to pixel electrodes corresponding to two display regions that correspond to the two display regions of the liquid crystal panel a, respectively, so that a polarization direction is rotated by about 90 degrees due to the electro-optic effect of the liquid crystal, i.e., the liquid crystal panel b is in the ON state. Note that a case where the polarization direction is rotated by 90 degrees is basically supposed to be an ideal case, and therefore such a case includes an intermediate state and a state of an elliptic polarization in which states the polarization direction is rotated by an angle other than 90 degrees. The following description will be based on the above supposition for ease of explanation.

This causes light which has passed through the polarizing plate B to be skewed in and to pass through the two display regions of the liquid crystal panel b, and is then entered into the polarizing plate C. Part of outgoing light from the polarizing plate C is entered into one of the display regions of the liquid crystal panel a, while a voltage is applied to the pixel electrodes corresponding to the one of the display regions so that the one of display regions is in the ON state. The part of the outgoing light from the polarizing plate C is further skewed by 90 degrees during passing through the liquid crystal panel a, and is directed toward the polarizing plate A. When the light which has been further skewed by 90 degrees in the liquid crystal panel a passes through the polarizing plate A, a bright display is carried out. This is because the polarizing plate A has a polarizing absorption axis that is perpendicular to a polarizing absorption axis of the polarizing plate C. Another part of the outgoing light from the polarizing plate C is entered into the other one of the display regions of the liquid crystal panel a, while no voltage is applied to the pixel electrodes corresponding to the other one of the display regions so that the other one of the display region is in the OFF state. The other part of the outgoing light is, without being skewed, directed toward the polarizing plate A. Since the polarizing absorption axis of the polarizing plate A is perpendicular to the polarizing absorption axis of the polarizing plate C, the light which has passed through the display region, which is in the OFF state, of the liquid crystal panel a is incapable of passing through the polarizing plate A. This causes a dark display to be carried out.

According to the state 1, (i) since the display state of the liquid crystal panel a corresponds to the display state of a composite image, the liquid crystal panel a is in a state of carrying out a display, and (ii) since the display state of the liquid crystal panel b is different from the display state of the composite image, the liquid crystal panel b is in the refreshment (ON) state. The refreshment (ON) state refers to a state in which a liquid crystal panel carries out a display that does not have direct relation to a display corresponding to a video image source while a voltage is applied to the pixel electrodes of the liquid crystal panel so that phosphor burn-in of the liquid crystal panel is prevented. For example, in the above example, the liquid crystal panel b carries out a solid display caused by the ON state over an entire screen and therefore does not display a particular pattern. Thus, it is possible to prevent phosphor burn-in.

State 2 shown in FIG. 6 shows a state reverse to the state 1. Specifically, it is assumed that a voltage is applied to the pixel electrodes corresponding to the two display regions of the liquid crystal panel a, respectively, so that the liquid crystal panel a is in the ON state. On the other hand, it is assumed that a voltage is applied to the pixel electrodes corresponding to one of the two display regions of the liquid crystal panel b so that the one of the display region is in the ON state, whereas no voltage is applied to the pixel electrodes corresponding to the other one of the display regions is in the OFF state.

This causes part of light which has passed through the polarizing plate B is entered into one of the two display regions of the liquid crystal panel b, while a voltage is applied to the pixel electrodes corresponding to the one of the display regions so that the one of the display regions is in the ON state. The part of the light is skewed by about 90 degrees in and passes through the one of the display regions. The part of the light is then entered into the polarizing plate C. The outgoing light from the polarizing plate C is entered into a display region of the liquid crystal panel a, while a voltage is applied to the pixel electrodes corresponding to the display region so that the display region is in the ON state. The light is skewed by 90 degrees in the display region, and directed toward the polarizing plate A. Since the polarizing absorption axis of the polarizing plate A is perpendicular to the polarizing absorption axis of the polarizing plate C, the light which has been skewed by 90 degrees in the liquid crystal panel b passes through the polarizing plate A. This causes a bright display to be carried out. Another part of the light which part has been entered into the other one of the display regions of the liquid crystal panel b which one of the display regions is in the OFF state is, without being skewed, directed toward the polarizing plate C. Since the polarizing plate B has a polarizing absorption axis that is perpendicular to the polarizing absorption axis of the polarizing plate C, the light which has not been skewed in the liquid crystal panel b is incapable of passing through the polarizing plate C, and therefore is not entered into the liquid crystal panel a. This causes a dark display to be carried out.

According to the state 2, (i) since the display state of the liquid crystal panel b corresponds to the display state of the composite image, the liquid crystal panel b is in a state of carrying out a display, and (ii) since the display state of the liquid crystal panel a corresponds to a solid image and therefore different from the display state of the composite image, the liquid crystal panel a is in the refreshment (ON) state.

The states 1 and 2 shown in FIG. 6 display an identical image. Thus, even when an identical image is continuously displayed, by alternately switching between the states 1 and 2, it is possible to always refresh any one of the liquid crystal panels at any given time. This allows prevention of phosphor burn-in in the liquid crystal panels.

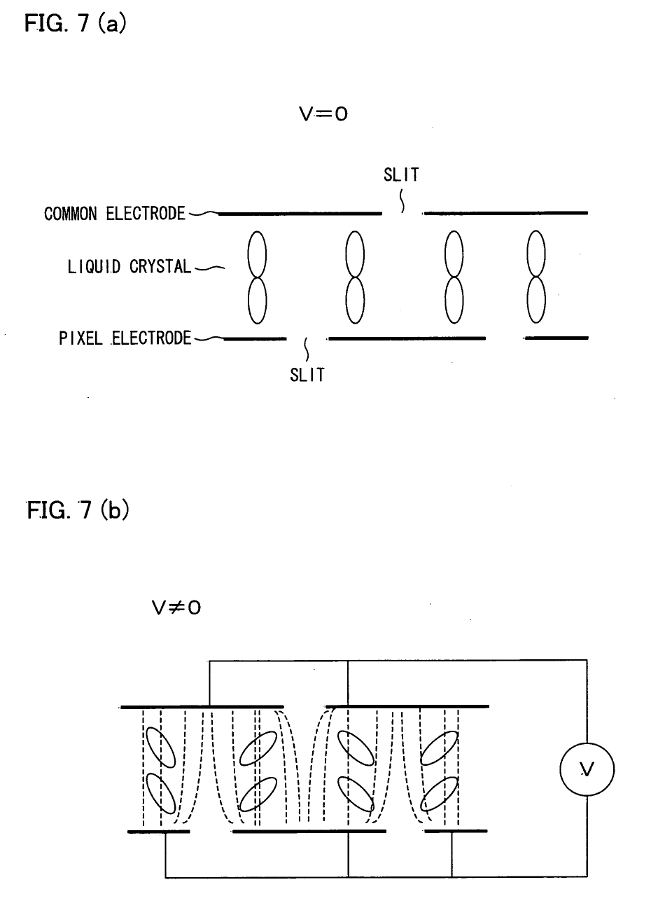

Other display modes to which the present embodiment is applicable are a Patterned Vertical Alignment (PVA) mode and the IPS mode. The PVA is a type in which a slit in the electrode is used in place of the alignment control projection used in the MVA. FIGS. 7(a) and 7(b) are schematic cross-sectional views showing the PVA mode. An alignment film in use is a vertical alignment film. A liquid crystal in use is a liquid crystal having a negative dielectric anisotropy. FIG. 7(a) shows a state in which liquid crystal molecules lie vertically while no voltage is applied. FIG. 7(b) shows a state in which a voltage is applied and a direction in which the liquid crystal is slanted is defined with use of an oblique electric field caused by the slit in the electrode. The angle of a polarizing plate in MVA is similarly applicable to PVA.

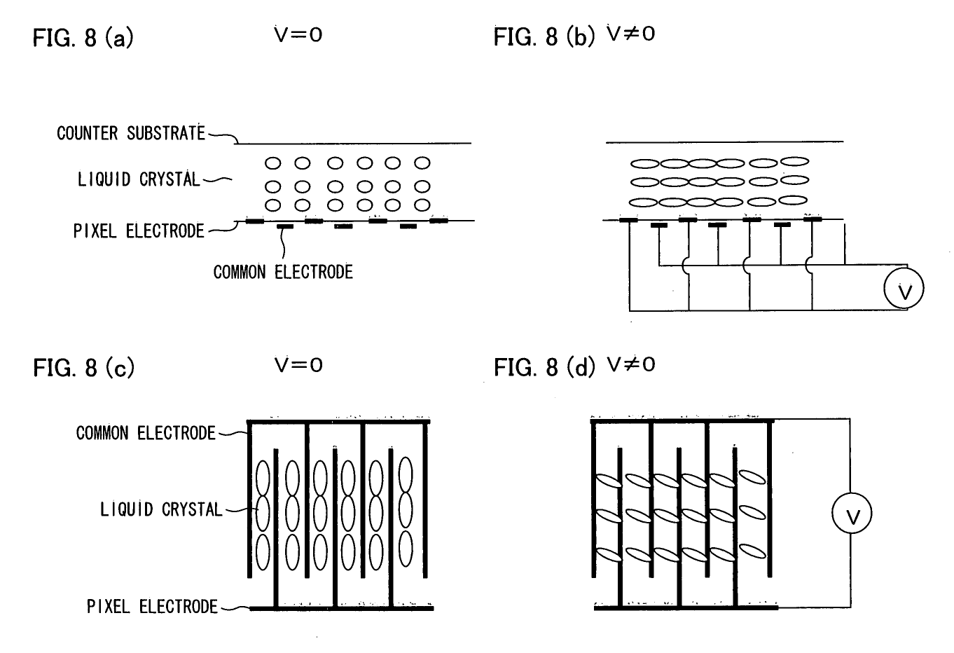

Further, according to the IPS mode, a liquid crystal is rotated within a plane parallel to the substrates, by applying an electric field parallel to the substrates. FIGS. 8(a) through 8(d) are explanatory views schematically illustrating the IPS mode. FIGS. 8(a) and 8(b) are schematic cross-sectional views, and FIGS. 8(c) and 8(d) are schematic cross-sectional views of a pixel. According to the IPS mode, a horizontal alignment film and, generally, a crystal liquid having a positive dielectric anisotropy are used. FIGS. 8(a) and 8(c) show a state in which the liquid crystal molecules lie in a rubbing direction of the horizontal alignment film (not shown) while no voltage is applied. FIGS. 8(b) and 8(d) show a state in which a voltage is applied, and the alignment direction of the liquid crystal is rotated by approximately 45 degrees in a horizontal plane by a lateral electric field generated by electrodes having a comb-teeth shape. Unlike other modes, a counter substrate does not have an electrode. The polarizing plates on both sides are arranged so as to be at angles of 0 degree and 90 degrees with respect to the rubbing direction, respectively. Modifications of the IPS mode exemplified by a mode in which electrodes are provided so as to have an L shape, and a mode in which (i) upper and lower electrodes by which an insulating film is sandwiched are provided and the lower electrode is provided to be solid within each of the pixels so that a fringe field is generated.

The following description deals with a case in which a panel is used in which an individual combination of a liquid crystal panel and a pair of polarizing plates by which the liquid crystal panel is sandwiched carries out a normally white (NW) display.

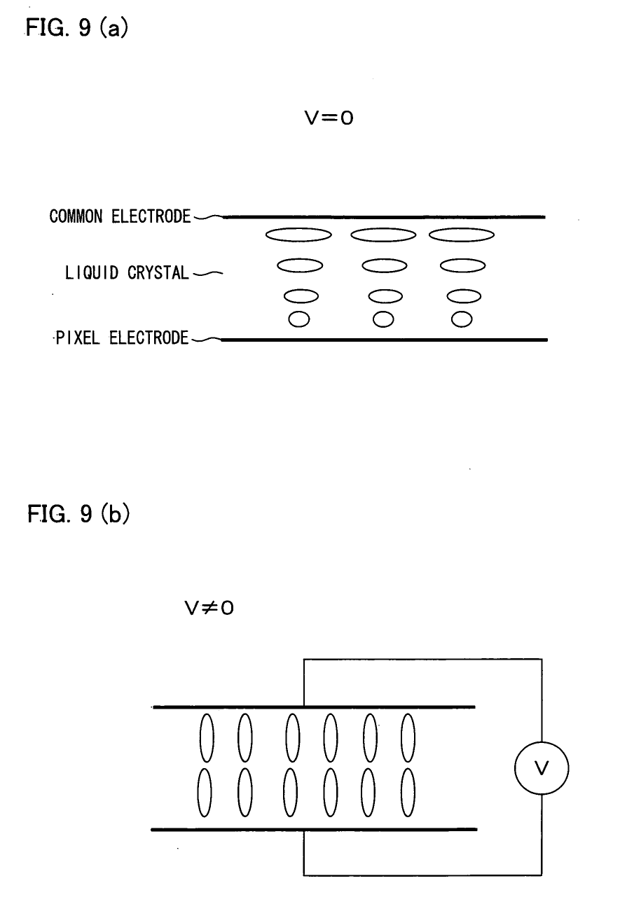

The NW type is represented by the Twisted Nematic (TN) type. FIGS. 9(a) and 9(b) are explanatory cross-sectional views schematically illustrating the TN type. FIG. 9(a) shows a state in which no voltage is applied and a rubbing is carried out to horizontal alignment films (not shown) so that liquid crystal molecules are twisted by approximately 90 degrees. The polarizing plates are provided parallel to rubbing directions of the alignment films of the upper and lower substrates, respectively. The axes of the polarizing plates are perpendicular to each other. A polarization direction of incident polarized light is rotated by 90 degrees in accordance with the twist of the liquid crystal molecules, and the light thus polarized passes through the polarizing plate provided on an outgoing side. This causes a bright display to be carried out. FIG. 9(b) shows a state in which a voltage is applied and the liquid crystal molecules lie vertically to the substrates when the liquid crystal having a positive dielectric anisotropy is used. In this case, polarized light changes very little its polarization direction, and therefore the polarized light does not pass through the polarizing plate provided on the outgoing side. This causes a dark display to be carried out.

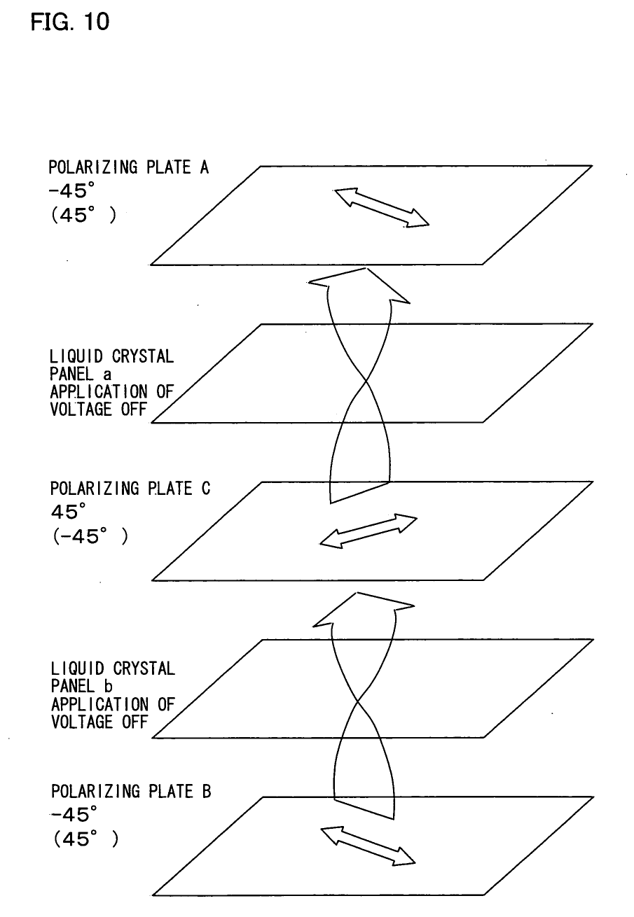

FIG. 10 shows a state in which no voltage is applied to each of the liquid crystal panels, in a case where an individual combination of a liquid crystal panel and a pair of polarizing plates by which the liquid crystal panel is sandwiched is a NW display. Specifically, according to the NW display, e.g., adopting a TN liquid crystal, for example, the liquid crystal panels a and b are arranged so as to skew incident light by 90 degrees and send out the light, when no voltage is applied.

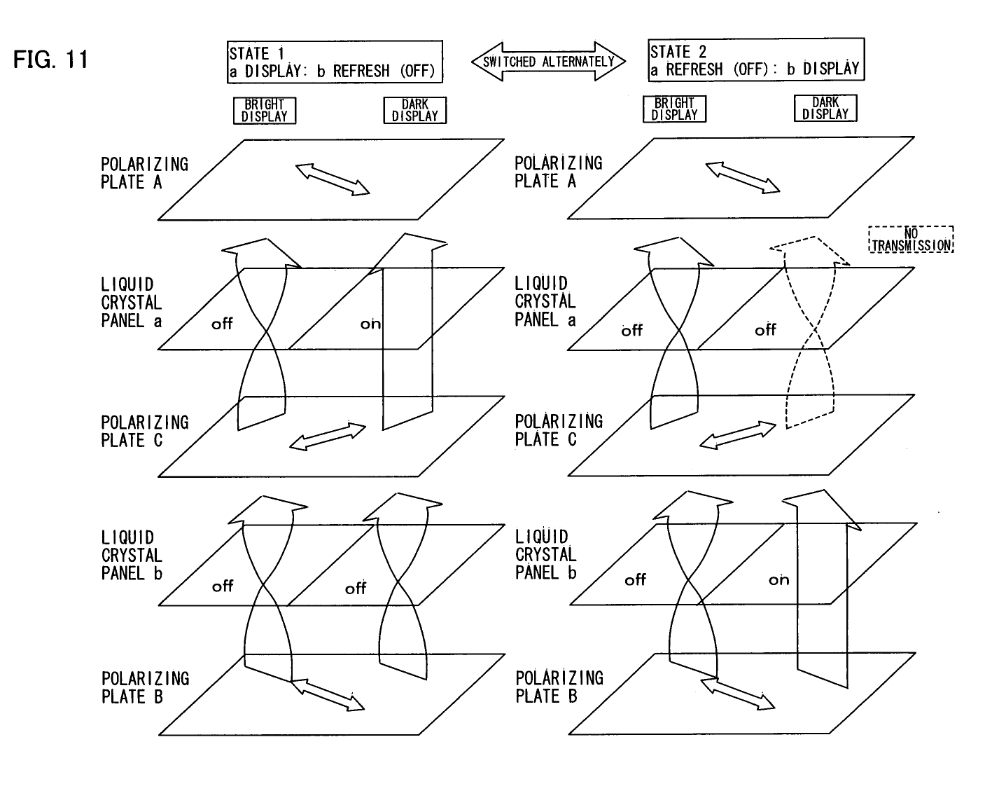

FIG. 11 is an explanatory diagram illustrating a switching of the display states (states 1, 2) obtained in the case of the NW display as shown in FIG. 10. FIG. 11 shows, for convenience of explanation, a case in which an image, combined by display images of the liquid crystal panels a and b, is a black-and-white image which has divided bright and dark display regions.

In state 1 shown in FIG. 11, one of two display regions of the liquid crystal panel a is set in an OFF state in which no voltage (or a voltage inadequate to cause an alignment of the liquid crystal to be changed) is applied to pixel electrodes corresponding to the one of the two display regions, whereas the other of the two display regions is set in an ON state in which a voltage is applied to pixel electrodes corresponding to the other one of the two display regions. Further, the liquid crystal panel b is set in the OFF state, while no voltage (or a voltage inadequate to cause an alignment of the liquid crystal to be changed) is applied to either of the two display regions corresponding to the two display regions of the liquid crystal panel a, respectively.

This causes light which has passed through the polarizing plate B, which forms a crossed Nichol relation with the polarizing plate C, to be skewed in and to pass through the two display regions of the liquid crystal panel b, and is then entered into the polarizing plate C. Part of outgoing light from the polarizing plate C is entered into one of the display regions of the liquid crystal panel a, while no voltage is applied to the pixel electrodes corresponding to the one of the display regions so that the one of display regions is in the OFF state. The part of the outgoing light from the polarizing plate C is further skewed by 90 degrees during passing through the liquid crystal panel a, and is directed toward the polarizing plate A. When the light which has been skewed by 90 degrees in the liquid crystal panel a passes through the polarizing plate A, a bright display is carried out. This is because the polarizing plate A has a polarizing absorption axis that is perpendicular to a polarizing absorption axis of the polarizing plate C. Another part of the outgoing light from the polarizing plate C is entered into the other one of the display regions of the liquid crystal panel a, while a voltage is applied to the pixel electrodes corresponding to the other one of the display regions so that the other one of the display region is in the ON state. The other part of the outgoing light is, without being skewed, directed toward the polarizing plate A. Since the polarizing absorption axis of the polarizing plate A is perpendicular to the polarizing absorption axis of the polarizing plate C, the light which has passed through the polarizing plate C and not been skewed by 90 degrees in the liquid crystal panel a is incapable of passing through the polarizing plate A. This causes a dark display to be carried out.

According to the state 1, (i) since the display state of the liquid crystal panel a corresponds to the display state of a composite image, the liquid crystal panel a is in a state of carrying out a display, and (ii) since the display state of the liquid crystal panel b is different from the display state of the composite image, the liquid crystal panel b is in the refreshment (OFF) state. The refreshment (OFF) state refers to a state in which a liquid crystal panel carries out a display that does not have direct relation to a display corresponding to a video image source while no voltage is applied to the pixel electrodes of the liquid crystal panel so that phosphor burn-in of the liquid crystal panel is prevented.

State 2 shown in FIG. 11 shows a state reverse to the state 1. Specifically, it is assumed that no voltage is applied to the pixel electrodes corresponding to the two display regions of the liquid crystal panel a, respectively, so that the liquid crystal panel a is in the OFF state. On the other hand, it is assumed that no voltage (or a voltage which is inadequate to change an alignment of the liquid crystal) is applied to the pixel electrodes corresponding to one of the two display regions of the liquid crystal panel b so that the one of the display region is in the OFF state, whereas a voltage is applied to the pixel electrodes corresponding to the other one of the display regions is in the ON state.

This causes part of light which has passed through the polarizing plate B to be entered into one of the two display regions of the liquid crystal panel b, while no voltage is applied to the pixel electrodes corresponding to the one of the display regions so that the one of the display regions is in the OFF state. The part of the light is skewed by 90 degrees in and passes through the one of the display regions. The part of the light passes through the polarizing plate C, and then is entered into a display region of the liquid crystal panel a, while no voltage is applied to the pixel electrodes corresponding to the display region so that the display region is in the OFF state. The light which has been entered into the display region of the liquid crystal panel a which display region is in the OFF state is skewed by 90 degrees in the display region and directed toward the polarizing plate A. The light which has passed through the polarizing plate C is skewed in the liquid crystal panel a and passes through the polarizing plate A. This causes a bright display to be carried out. This is because the polarizing plate A has a polarizing absorption axis that is perpendicular to a polarizing absorption axis of the polarizing plate C. Another part of the light which part has been entered into the other one of the display regions of the liquid crystal panel b, while a voltage is applied to the pixel electrodes corresponding to the other one of the display regions so that the other one of the display regions is in the ON state. The light is sent out without being skewed, and therefore is not entered into the polarizing plate C, which has a polarizing absorption axis that is perpendicular to the polarizing absorption axis of the polarizing plate B. As a result, the light does not pass through the liquid crystal panel a. This causes a dark display to be carried out.

According to the state 2, (i) since the display state of the liquid crystal panel b corresponds to the display state of a composite image, the liquid crystal panel b is in a state of carrying out a display, and (ii) since the display state of the liquid crystal panel a is a solid image and therefore different from the display state of the composite image, the liquid crystal panel a is in the refreshment (OFF) state.

The states 1 and 2 shown in FIG. 11 display an identical image. Thus, even when an identical image is continuously displayed, by alternately switching between the states 1 and 2, it is possible to always refresh any one of the liquid crystal panels at any given time. This allows prevention of phosphor burn-in in the liquid crystal panels. In a case where the liquid crystal panels of the NW display is used in the present embodiment, there is an advantage in that, unlike the case where liquid crystal panels of the NB display is used, the driving of the liquid crystal panel in a refreshment state can be off even while a composite image is displayed. Therefore, power consumption can be reduced.

The following description deals with a specific display switching control, for each of the liquid crystal panels, causing a composite display image to be obtained from display images of the liquid crystal panels a and b in the liquid crystal display device 100. The following explains a case in which, as shown in FIG. 1, a composite image is identical with a display image of any one of the liquid crystal panels. Switching of the displays of the liquid crystal panels is performed for every frame.

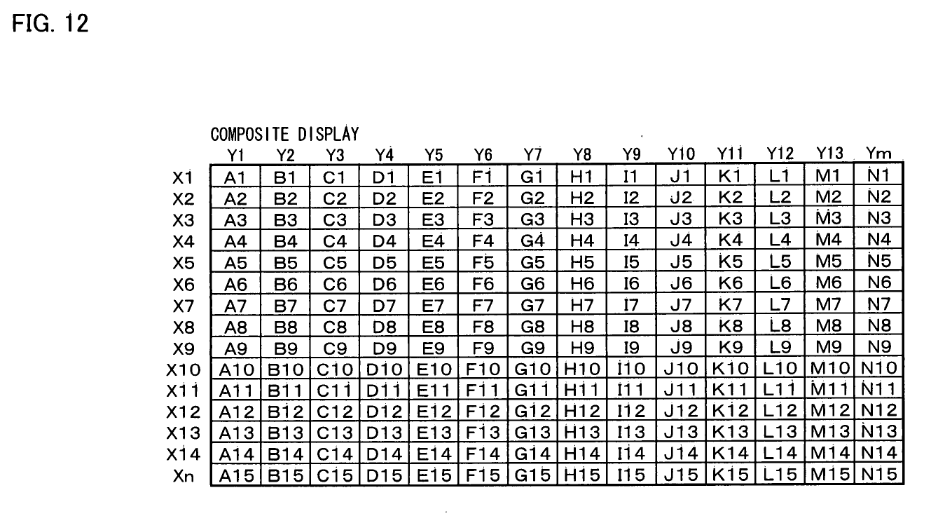

FIG. 12 shows a composite display image, where X1 through Xn refer to gate electrodes, and Y1 through Ym refer to source electrodes. When display voltages are set for pixel electrodes provided so as to correspond to intersections of the electrodes, respectively, the intersections are assigned reference symbols such as A1 and A2.

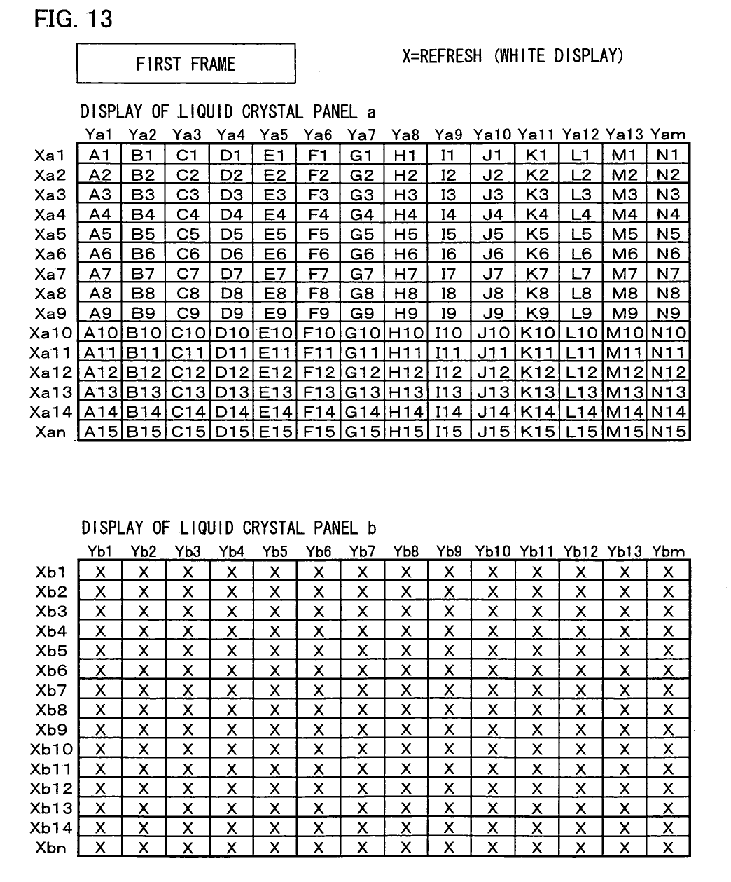

FIGS. 13, 15, and 17 show display states of the liquid crystal panels a and b for respective frames. The X assigned to each of the pixel electrodes indicates that a voltage for a white display is set. The white display in this case is intended to mean a white display that is carried out when it does not have relation to the image to be displayed. As described above, in the case of using liquid crystal panels of the normally white type such as a TN type as an individual panel serving as a display device, a white display is carried out by applying no voltage or by applying a voltage that causes an alignment of the liquid crystal not to be changed. Therefore, a voltage of about 0 is set to the pixel electrodes indicated by “X”. In the case of using liquid crystal panels of the normally black type such as a VA type as a display device formed of an individual panel, a white display is carried out by applying a voltage. Therefore, a predetermined voltage is set to the pixel electrodes indicated by “X”. Note that a voltage, causing a white display to be carried out, is set for the pixel electrodes indicated by “X”, in accordance with a display mode.

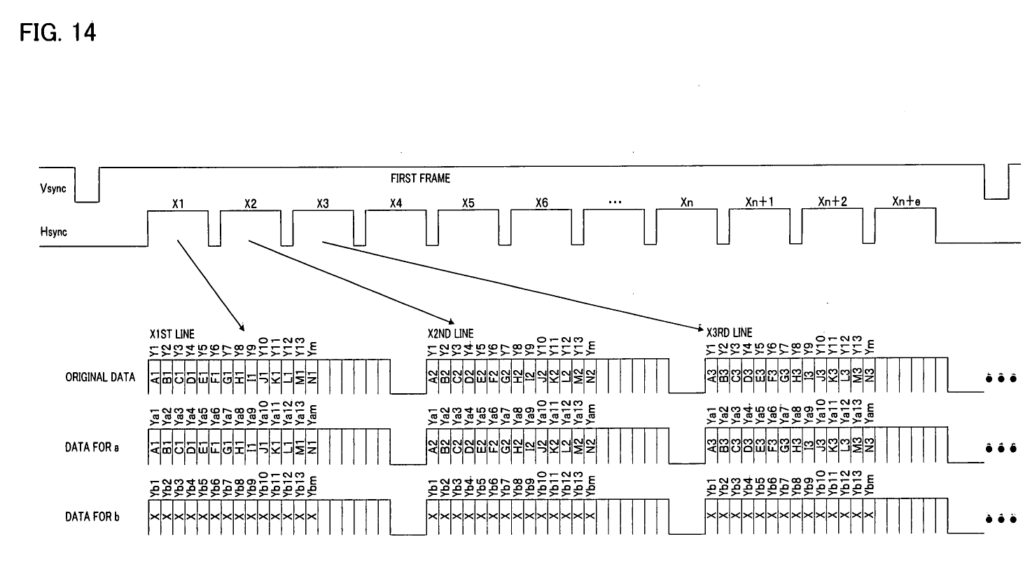

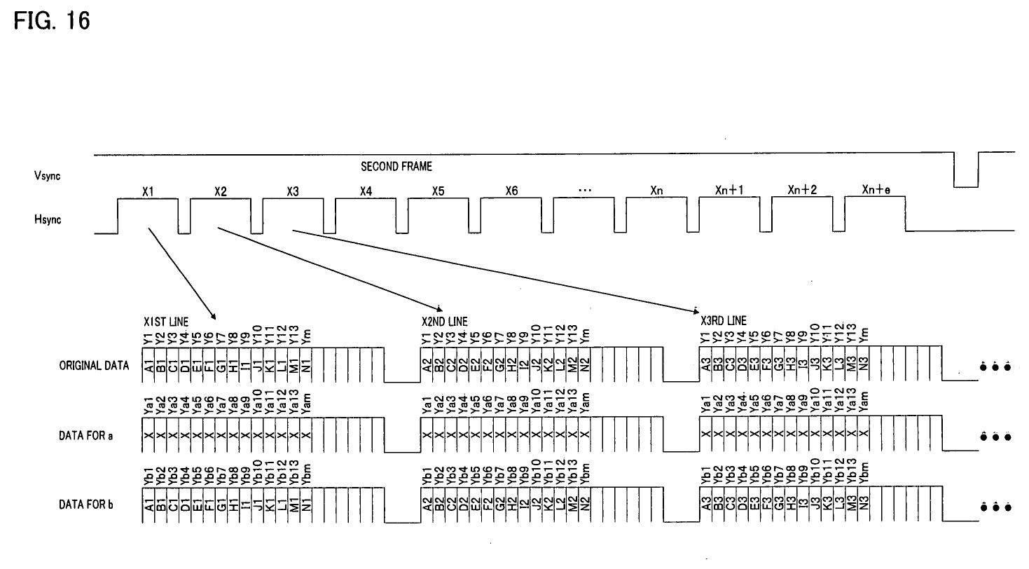

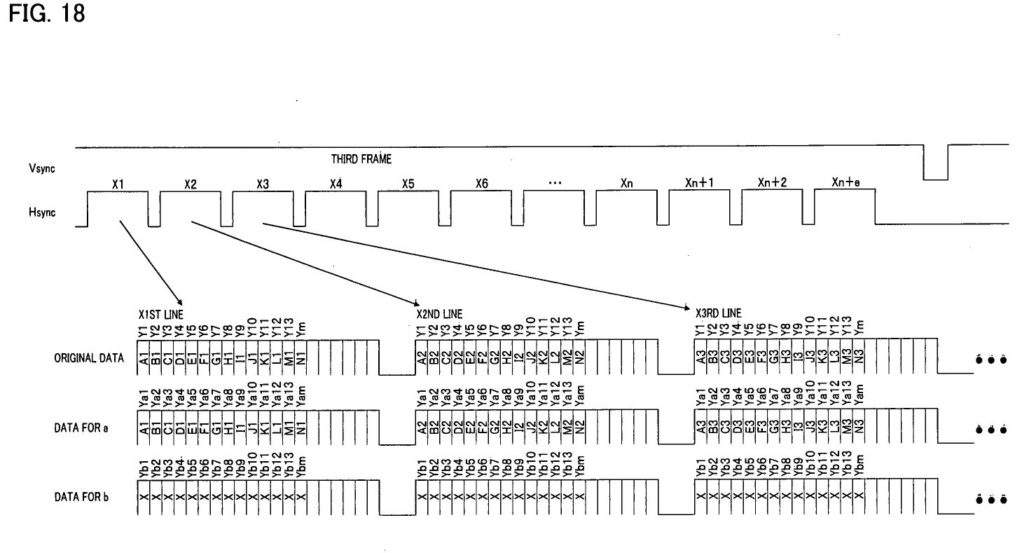

FIGS. 14, 16, and 18 are timing charts showing timing at which the voltages are applied to the liquid crystal panels a and b for the respective frames. FIG. 14 is a timing chart during a first frame; FIG. 16 is a timing chart during a second frame; and FIG. 18 is a timing chart during a third frame.

During the first frame, as shown in FIG. 13, voltages to be applied for displaying an image is set to all of the pixel electrodes of the liquid crystal panel a. In this example, a voltage identical with a voltage for the composite display image is set. On the other hand, the voltage (X) for a white display is set to all of the pixel electrodes of the liquid crystal panel b. As shown in FIG. 14, during the first frame, (i) data for the liquid crystal panel a (data for a) and (ii) data for the liquid crystal panel b (data for b) are separated from original data for displaying the composite display image, in accordance with timing of a vertical synchronization signal Vsync and a horizontal synchronization signal Hsync, and are then supplied to the liquid crystal panels, respectively. While the original data is supplied to the liquid crystal panel a, data (X) for a white display is supplied to the liquid crystal b.

During the first frame, the liquid crystal panel b is in the refreshment state.

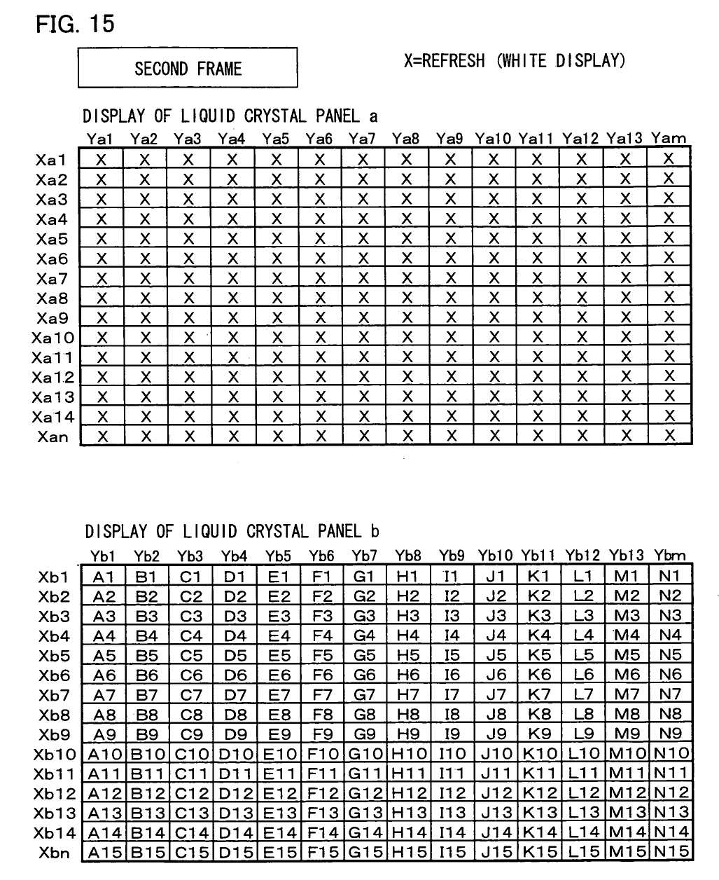

During the second frame, as opposed to the first frame, as shown in FIG. 15, the voltage for a white display (X) is set to all of the pixel electrodes of the liquid crystal panel a. Further, voltages to be applied for displaying an image are set to all of the pixel electrodes of the liquid crystal panel b. A voltage identical with the voltage for the composite display image is set. As shown in FIG. 16, during the second frame, (i) data for the liquid crystal panel a (data for a) and (ii) data for the liquid crystal panel b (data for b), are separated from the original data for displaying the composite display image in accordance with timing of the vertical synchronization signal Vsync and the horizontal synchronization signal Hsync, and are then supplied to the liquid crystal panels, respectively. While the original data is supplied to the liquid crystal panel b, data (X) for a white display is supplied to the liquid crystal panel a.

During the second frame, the liquid crystal panel a is in the refreshment state.

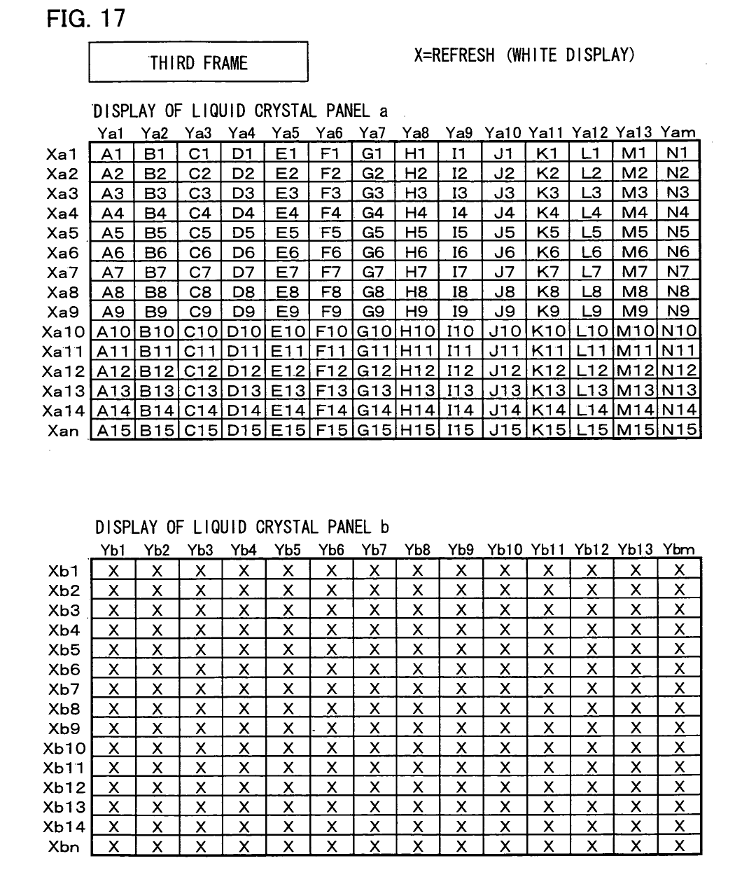

Subsequently, during the third frame, as shown in FIGS. 17 and 18, the liquid crystal panels a and b show display states identical to those during the first frame. During the third frame, the liquid crystal panel b is in the refreshment state again.

It is possible for any one of the liquid crystal panels to be surely in a refreshment state, by similarly switching the display states of the liquid crystal panels a and b for every frame, e.g., for a fourth frame and for a fifth frame.

The above description deals with an example in which, as shown in FIG. 1, a display control is performed so that either one of the two liquid crystal panels carries out a display identical with a composite display image, and that the other liquid crystal panel is entirely in the refreshment state. However, the present invention is not limited to this, provided that it should allow prevention of phosphor burn-in of the liquid crystal panels. Embodiment 2 below describes another example of prevention of phosphor burn-in.

According to Embodiment 1, since (i) the polarizing plates A and C are provided to meet a crossed Nichol relation and (ii) the polarizing plates B and C are provided to meet a crossed Nichol relation, it is possible, as far as a front direction is concerned, for an absorption axis of a neighboring polarizing plate to block light that leaks in a transmission axis direction of a polarizing plate. Further, as far as an oblique direction is concerned, even if a Nichol angle, defined by the polarization axes of the adjacent polarizing plates, is not maintained, no increase in light amount occurs due to a light leak. In other words, a defective black display is less likely to occur when the Nichol angle becomes wide in case of an oblique viewing angle.

In a case where henat least two liquid crystal panels are combined with one another so that neighboring polarizing plates, by which a liquid crystal panel is sandwiched, are provided to meet crossed Nichol relations, there are at least three of the polarizing plates. When the neighboring polarizing plates are provided to meet a crossed Nichol relation, it is possible to significantly improve light shut-out properties in the front direction and in the oblique direction. This allows a significant improvement in contrast.

Contrast can be further improved by causing each of the liquid crystal panels combined with one another to carry out a display in accordance with a display signal.

### [Embodiment 2] The following description deals with another embodiment of the present invention.

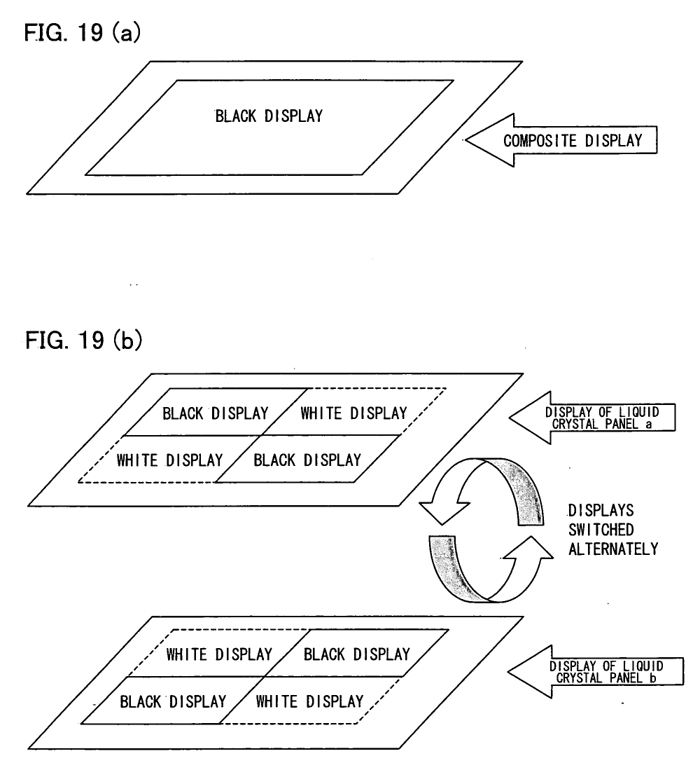

FIGS. 19(a) and 19(b) are explanatory views schematically illustrating an example of a display control in accordance with the present embodiment.

According to a display control of the present embodiment, as shown in FIGS. 19(a) and 19(b), corresponding regions of the liquid crystal panels a and b carry out reverse displays, i.e., when a region of one of the liquid crystal panels carries out a black display, its corresponding region of the other liquid crystal panel carries out a white display. By combining the displays of the two liquid crystal panels, a black display is carried out as a whole. In this case also, the displays of the liquid crystal panels a and b are switched alternately (see FIG. 1).

The following description deals with a specific display switching control, for each of the liquid crystal panels, causing a composite display image to be obtained from display images of the liquid crystal panels a and b in the liquid crystal display device 100. The following explains a case in which, as shown in FIG. 19(a), a composite image is formed by the display images of both of the liquid crystal panels in FIG. 19(b), and the display images are switched for every frame.

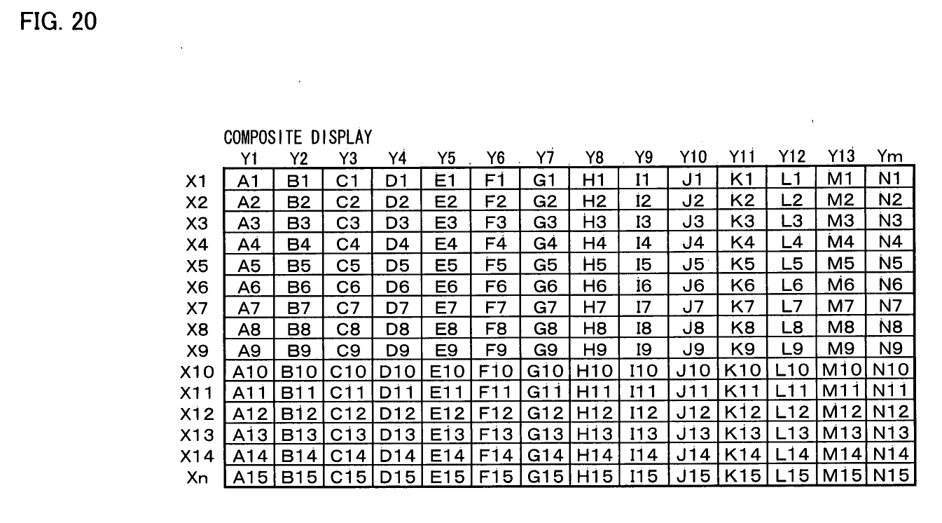

Similarly to FIG. 12, FIG. 20 shows a composite display image, where X1 through Xn refer to gate electrodes, and Y1 through Ym refer to source electrodes. When display voltages are set for pixel electrodes provided so as to correspond to intersections of the electrodes, respectively, the intersections are assigned reference symbols such as A1 and A2.

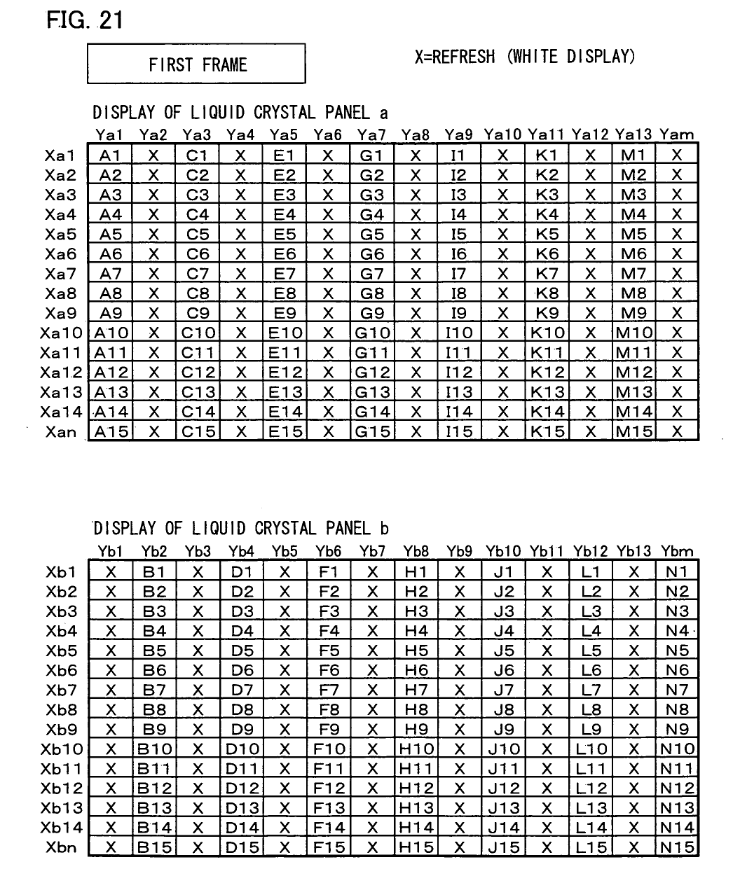

FIGS. 21, 22, and 23 show display states of the liquid crystal panels a and b for respective frames. The X assigned to each of the pixel electrodes indicates that a voltage for a white display is set. The white display in this case is intended to mean a white display that is carried out when it does not have relation to the image to be displayed. As described above, in the case of using liquid crystal panels of the normally white type such as a TN type as an individual panel serving as a display device, a white display is carried out by applying no voltage or by applying a voltage that causes an alignment of the liquid crystal not to be changed. Therefore, a voltage of about 0 is set for the pixel electrodes indicated by “X”. In the case of using liquid crystal panels of the normally black type such as a VA type as a display device formed of an individual panel, a white display is carried out by applying a voltage. Therefore, a predetermined voltage is set to the pixel electrodes indicated by “X”. Note that a voltage, causing a white display to be carried out, is set for the pixel electrodes indicated by “X”, in accordance with a display mode.

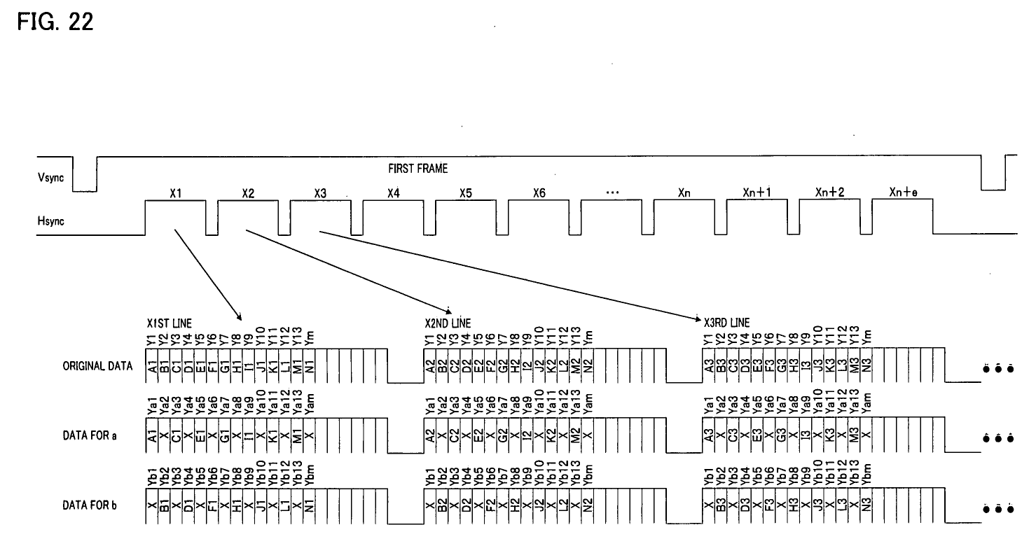

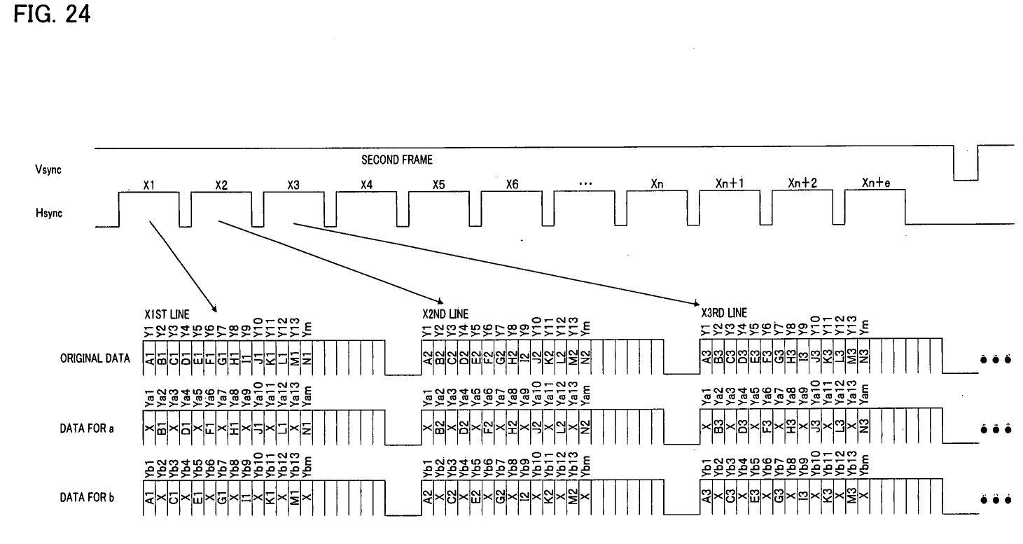

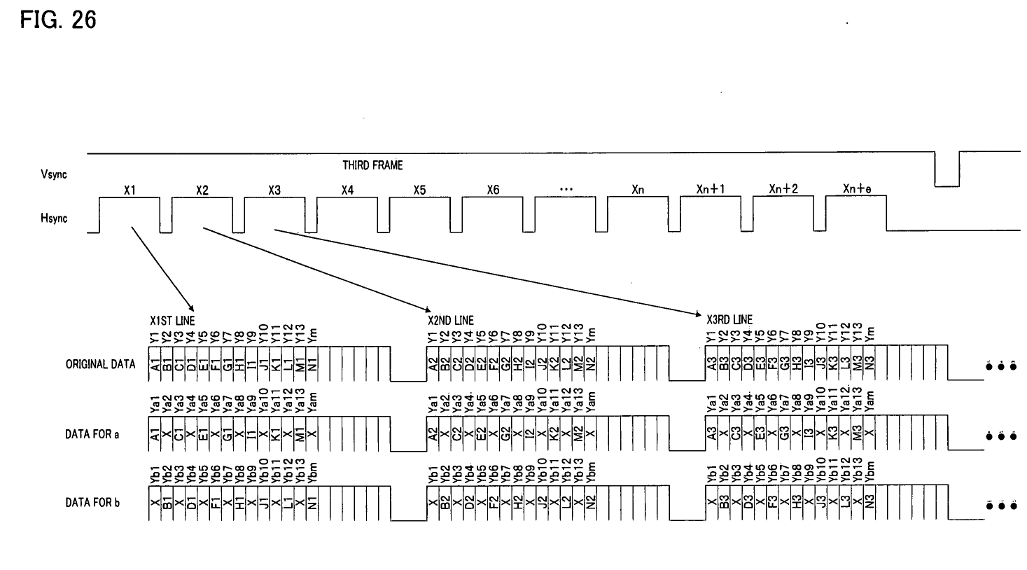

FIGS. 22, 24, and 26 are timing charts showing timing at which the voltages are applied to the liquid crystal panels a and b for the respective frames. FIG. 22 is a timing chart during a first frame; FIG. 24 is a timing chart during a second frame; and FIG. 26 is a timing chart during a third frame.

During the first frame, as shown in FIG. 21, voltages for displaying an image and a voltage for a white display (X) are set alternately for the source electrodes of the liquid crystal panels a and b. The voltage for a white display is set for source lines of the liquid crystal panel b, which source lines correspond to source lines of the liquid crystal panel a and for which source lines voltages identical with the voltage for the composite display image are set. Similarly, the voltage for a white display is set for source lines of the liquid crystal panel a, which source lines correspond to source lines of the liquid crystal panel b and for which source lines voltages identical with the voltage for the composite display image are set.

As shown in FIG. 22, during the first frame, (i) data for the liquid crystal panel a (data for a) and (ii) data for the liquid crystal panel b (data for b) are separated from original data for displaying the composite display image for every source line, in accordance with timing of a vertical synchronization signal Vsync and a horizontal synchronization signal Hsync, and are then supplied to the liquid crystal panels, respectively.

In the case of the above display control, during the first frame, the source lines of both of the liquid crystal panels a and b which source lines contribute to a white display are in the refreshment state.

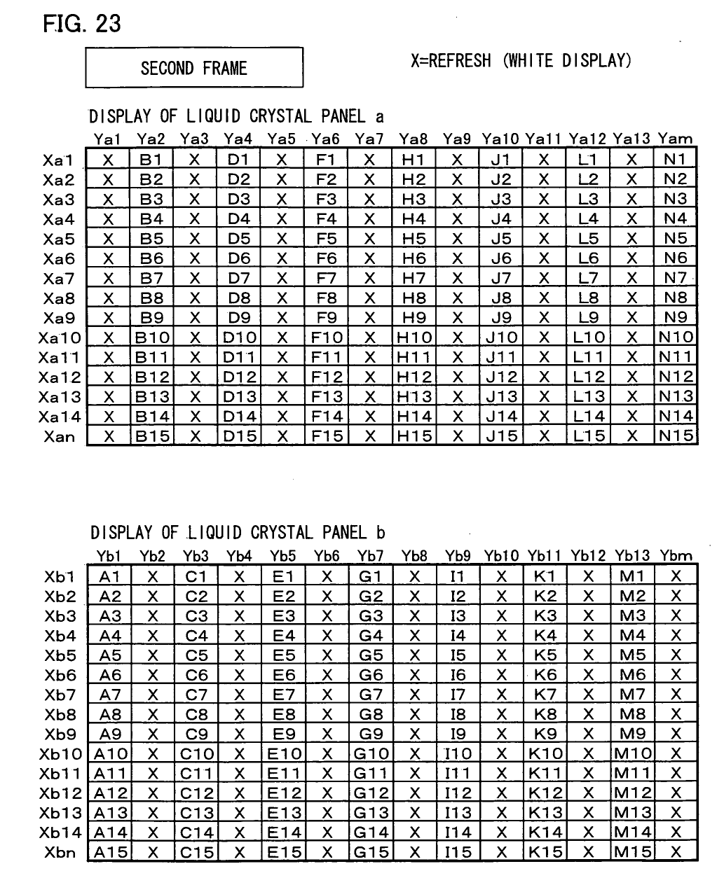

Subsequently, during the second frame, as opposed to the first frame, as shown in FIG. 23, the voltage for the composite display image is set to the source lines of the liquid crystal panel a, to which source lines the voltage for a white display is applied during the first frame. Similarly, the voltage for the composite display image is set to the source lines of the liquid crystal panel b, to which source lines the voltage for a white display is applied during the first frame. As a result, when the display images of the liquid crystal panels a and b are composed, the same composite display image as in the first frame is displayed.

As shown in FIG. 24, during the second frame, (i) data for the liquid crystal panel a (data for a) and (ii) data for the liquid crystal panel b (data for b) are separated from original data for displaying the composite display image, in accordance with timing of a vertical synchronization signal Vsync and a horizontal synchronization signal Hsync, and are then supplied to the liquid crystal panels, conversely to the first frame.

In the case of the above display control, during the second frame, similarly to the first frame, the source lines of both of the liquid crystal panels a and b which source lines contribute to a white display are in the refreshment state.

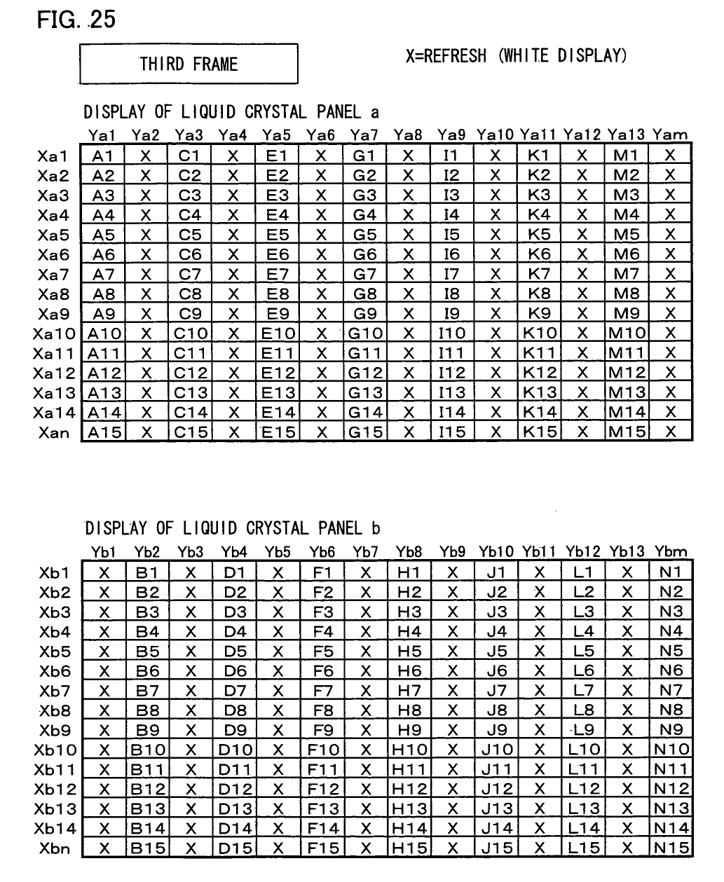

Subsequently, during the third frame, as shown in FIGS. 25 and 26, the liquid crystal panels a and b are in display states identical to those in the first frame.

It is possible for one region of both of the liquid crystal panels to be surely in a refreshment state, by similarly switching the display states of the liquid crystal panels a and b for every frame, e.g., for a fourth frame and for a fifth frame.

The above description deals with an arrangement in which the voltage for a composite display image and the voltage for a white display are applied to the respective source lines of the liquid crystal panels. Alternatively, the voltage for a composite display image and the voltage for a white display may be applied alternately to each of the pixels, i.e., to each dot of the liquid crystal panels. The following description deals with a dot display control.

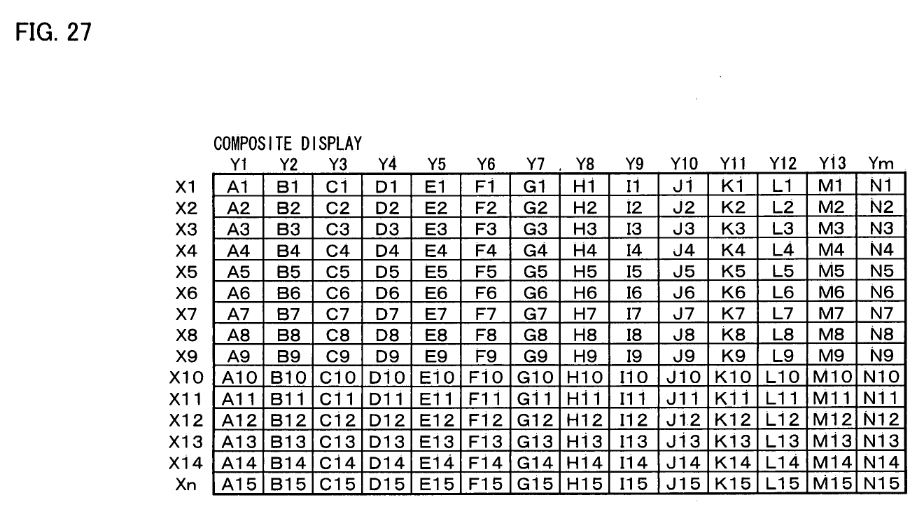

For example, similarly to FIG. 12, FIG. 27 shows a composite display image, where X1 through Xn refer to gate electrodes, and Y1 through Ym refer to source electrodes. When display voltages are set for pixel electrodes provided so as to correspond to intersections of the electrodes, respectively, the intersections are assigned reference symbols such as A1 and A2.

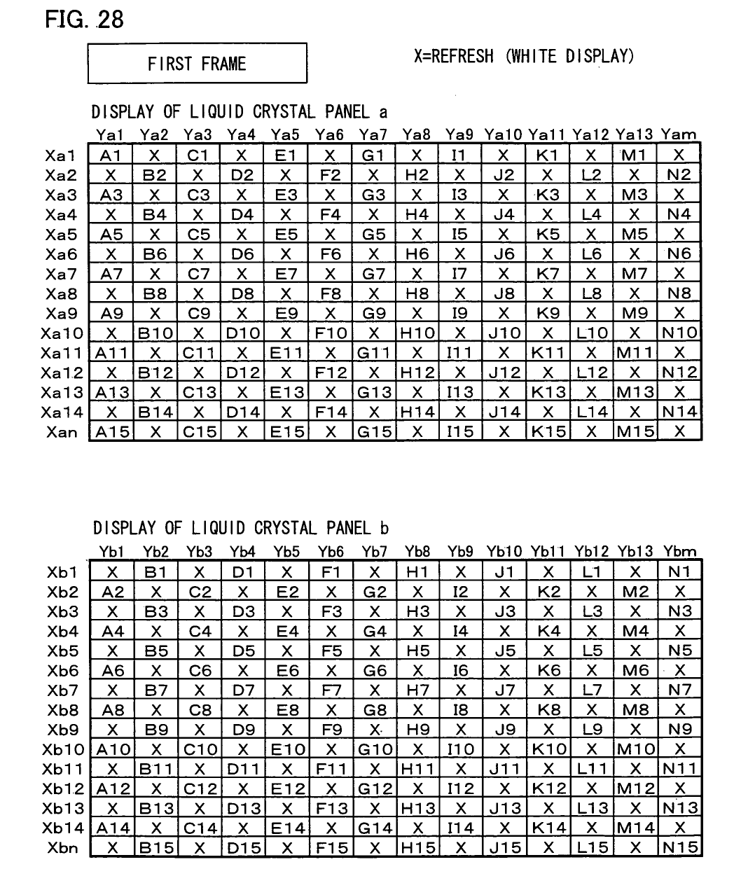

FIGS. 28, 30, and 32 show display states of the liquid crystal panels a and b for respective frames. The X assigned to each of the pixel electrodes indicates that a voltage for a white display is set. The white display in this case is intended to mean a white display that is carried out when it does not have relation to the image to be displayed. As described above, in the case of using liquid crystal panels of the normally white type, a white display is carried out by applying no voltage. Therefore, a voltage of about 0 (or a voltage that causes an alignment of the liquid crystal not to be changed) is set to the pixel electrodes indicated by “X”. In the case of using liquid crystal panels of the normally black type, a white display is carried out by applying a voltage. Therefore, a predetermined voltage is set to the pixel electrodes indicated by “X”. Note that a voltage, causing a white display to be carried out, is set for the pixel electrodes indicated by “X”, in accordance with a display mode.

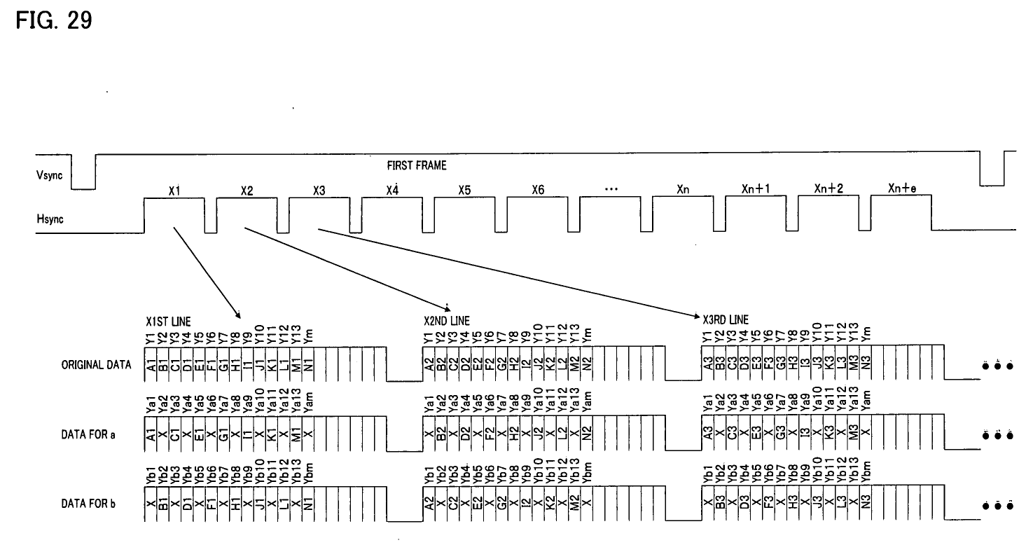

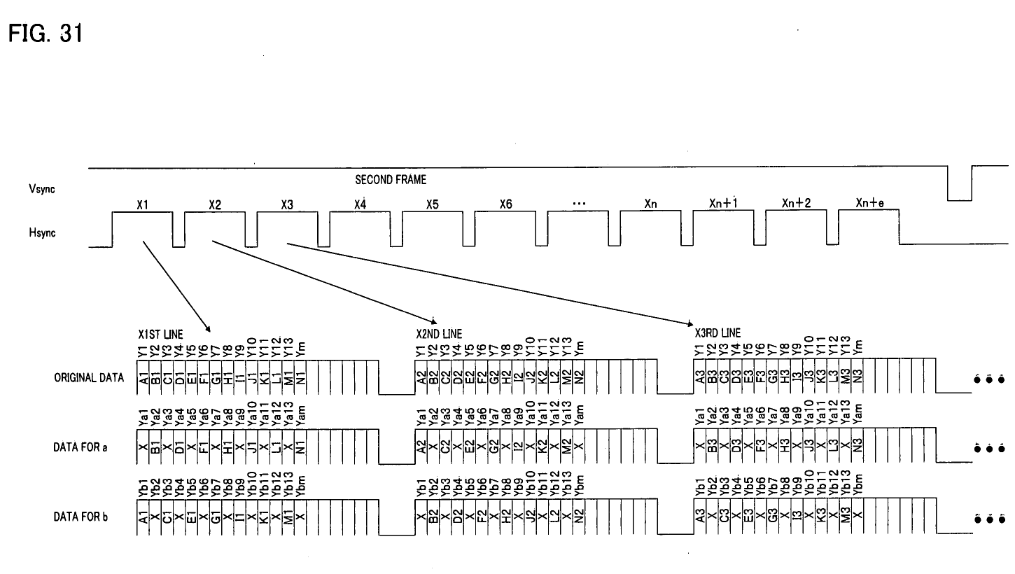

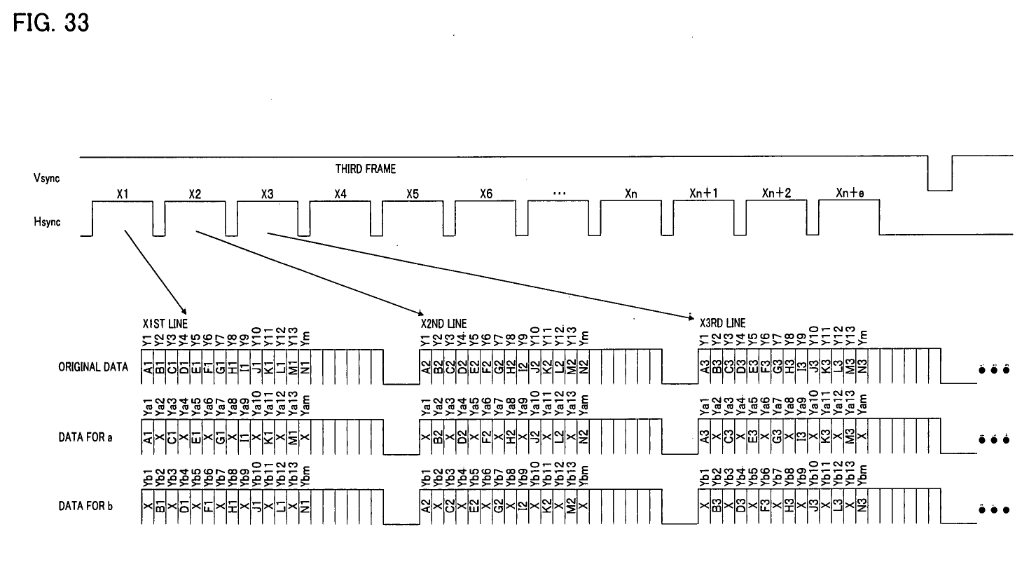

FIGS. 29, 31, and 33 are timing charts showing timing at which the voltages are applied to the liquid crystal panels a and b for the respective frames. FIG. 29 is a timing chart during a first frame; FIG. 31 is a timing chart during a second frame; and FIG. 33 is a timing chart during a third frame.

During the first frame, as shown in FIG. 28, voltages for displaying an image and a voltage for a white display (X) are set alternately for the pixel electrodes of the liquid crystal panels a and b. The voltage for a white display is set for pixel electrodes of the liquid crystal panel b, which pixel electrodes correspond to pixel electrodes of the liquid crystal panel a and for which pixel electrodes voltages identical with the voltage for the composite display image are set. Similarly, the voltage for a white display is set for pixel electrodes of the liquid crystal panel a, which pixel electrodes correspond to pixel electrodes of the liquid crystal panel b and for which pixel electrodes voltages identical with the voltage for the composite display image are set.

As shown in FIG. 29, during the first frame, (i) data for the liquid crystal panel a (data for a) and (ii) data for the liquid crystal panel b (data for b) are separated from original data for displaying the composite display image for every pixel electrode, in accordance with timing of a vertical synchronization signal Vsync and a horizontal synchronization signal Hsync, and are then supplied to the liquid crystal panels, respectively.

In the case of the above display control, during the first frame, the pixel electrodes of both of the liquid crystal panels a and b which pixel electrodes contribute to a white display are in the refreshment state.

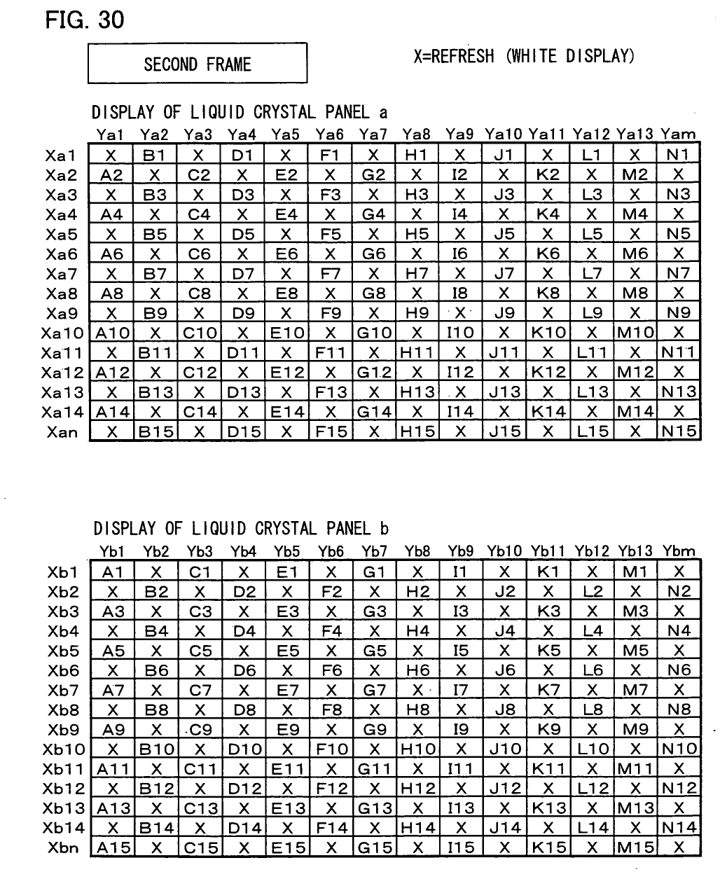

Subsequently, during the second frame, as opposed to the first frame, as shown in FIG. 30, the voltage for the composite display image is set to the pixel electrodes of the liquid crystal panel a, to which pixel electrodes the voltage for a white display is applied during the first frame. Similarly, the voltage for the composite display image is set to the pixel electrodes of the liquid crystal panel b, to which pixel electrodes the voltage for a white display is applied during the first frame. As a result, when the display images of the liquid crystal panels a and b are composed, the same composite display image as in the first frame is displayed.

As shown in FIG. 31, during the second frame, (i) data for the liquid crystal panel a (data for a) and (ii) data for the liquid crystal panel b (data for b) are separated from original data for displaying the composite display image, in accordance with timing of a vertical synchronization signal Vsync and a horizontal synchronization signal Hsync, and are then supplied to the liquid crystal panels, conversely to the first frame.

In the case of the above display control, during the second frame, similarly to the first frame, the pixel electrodes of both of the liquid crystal panels a and b which pixel electrodes contribute to a white display are in the refreshment state.

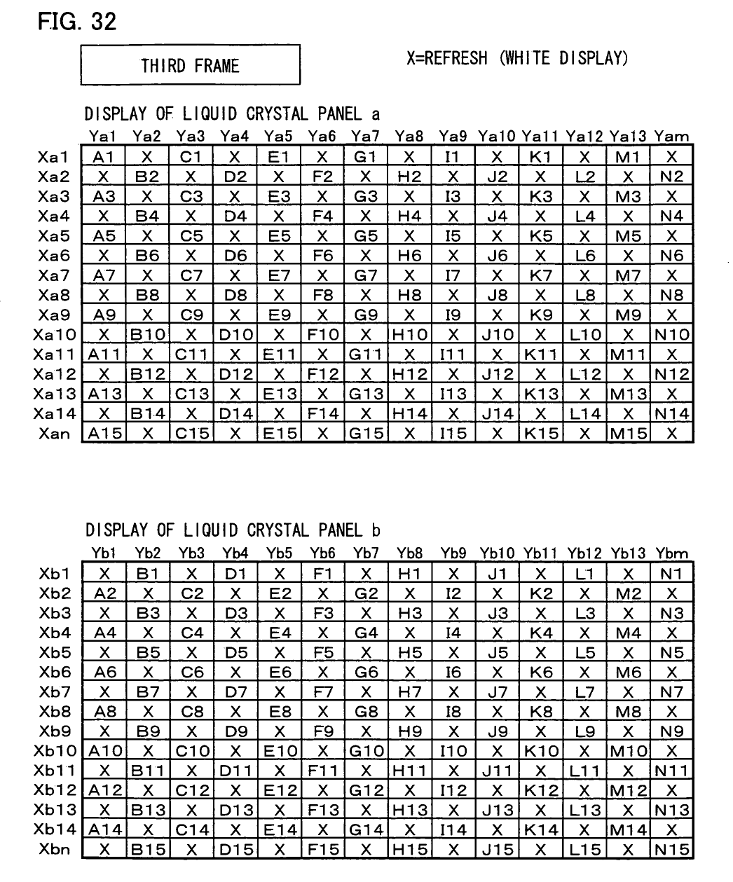

Subsequently, during the third frame, as shown in FIGS. 32 and 33, the liquid crystal panels a and b are in display states identical to those in the first frame.

It is possible for one region of both of the liquid crystal panels to be surely in a refreshment state, by similarly switching the display states of the liquid crystal panels a and b for every frame, e.g., for a fourth frame and for a fifth frame.

The following description deals with another display control of reversing dots.

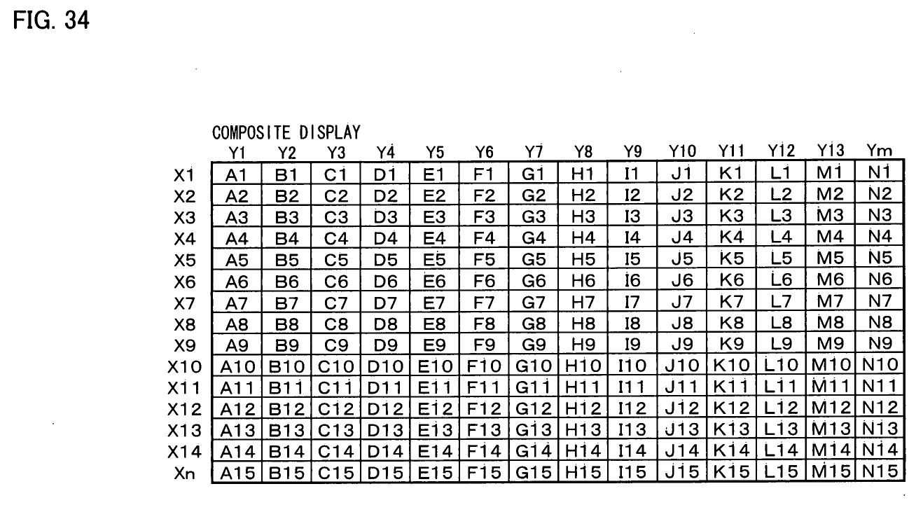

Similarly to FIG. 12, FIG. 34 shows a composite display image, where X1 through Xn refer to gate electrodes, and Y1 through Ym refer to source electrodes. When display voltages are set for pixel electrodes provided so as to correspond to intersections of the electrodes, respectively, the intersections are assigned reference symbols such as A1 and A2.

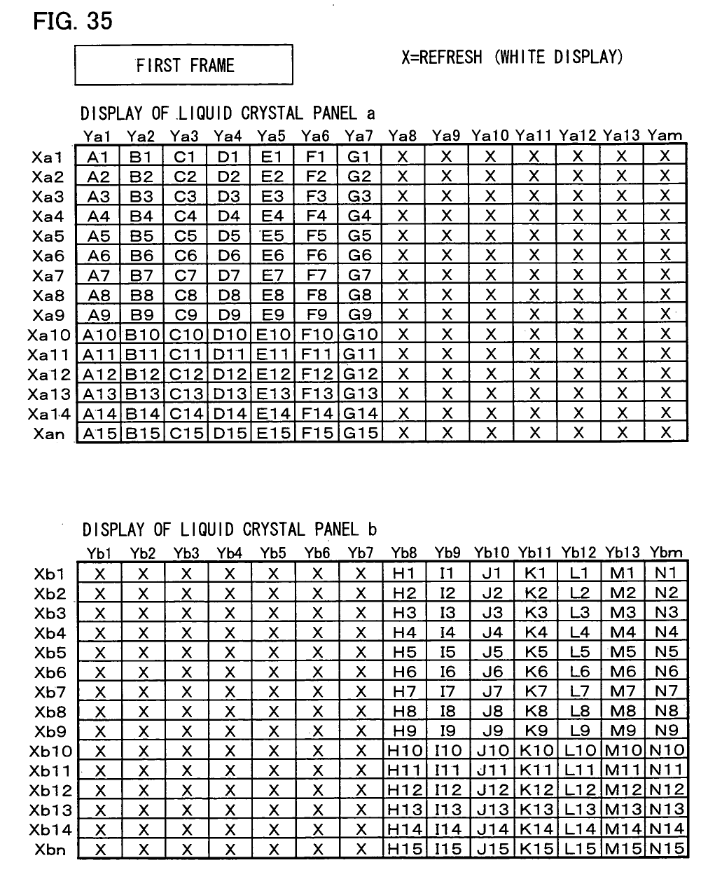

FIGS. 35, 37, and 39 show display states of the liquid crystal panels a and b for respective frames. The X assigned to each of the pixel electrodes indicates that a voltage for a white display is set. The white display in this case is intended to mean a white display that is carried out when it does not have relation to the image to be displayed. As described above, in the case of using liquid crystal panels of the normally white type, a white display is carried out by applying no voltage. Therefore, a voltage of about 0 (or a voltage that causes an alignment of the liquid crystal not to be changed) is set to the pixel electrodes indicated by “X”. In the case of using liquid crystal panels of the normally black type, a white display is carried out by applying a voltage. Therefore, a predetermined voltage is set to the pixel electrodes indicated by “X”. Note that a voltage, causing a white display to be carried out, is set for the pixel electrodes indicated by “X”, in accordance with a display mode.

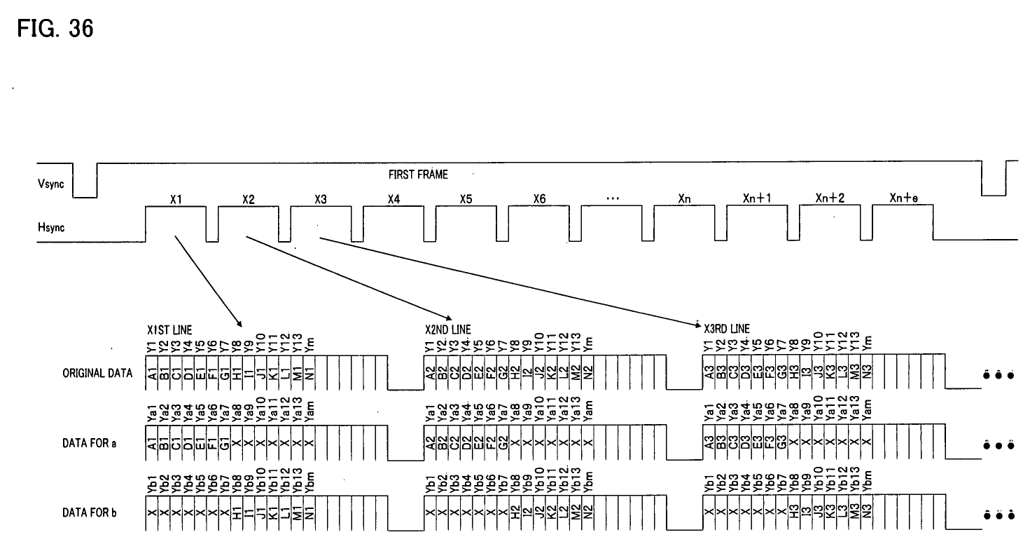

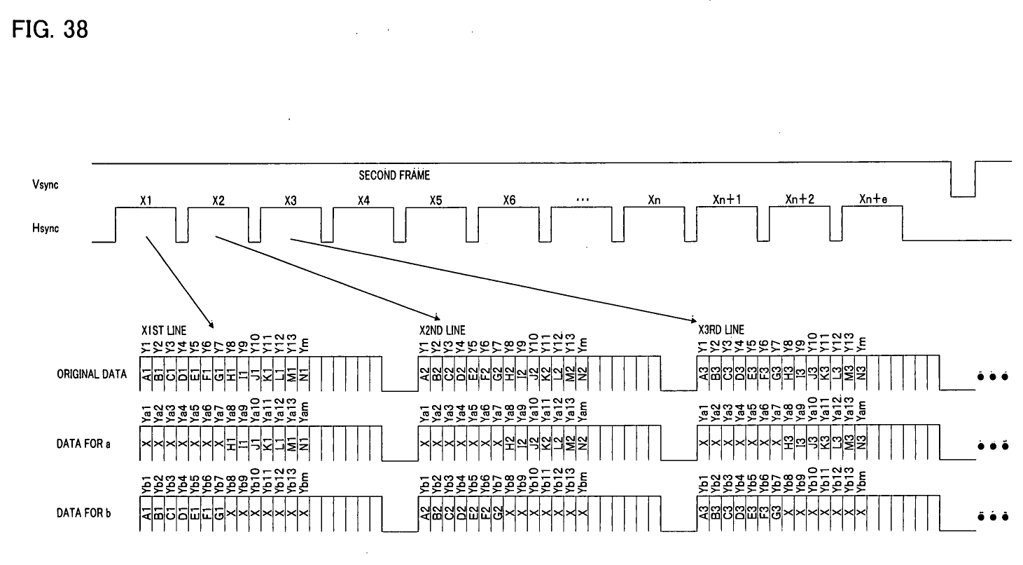

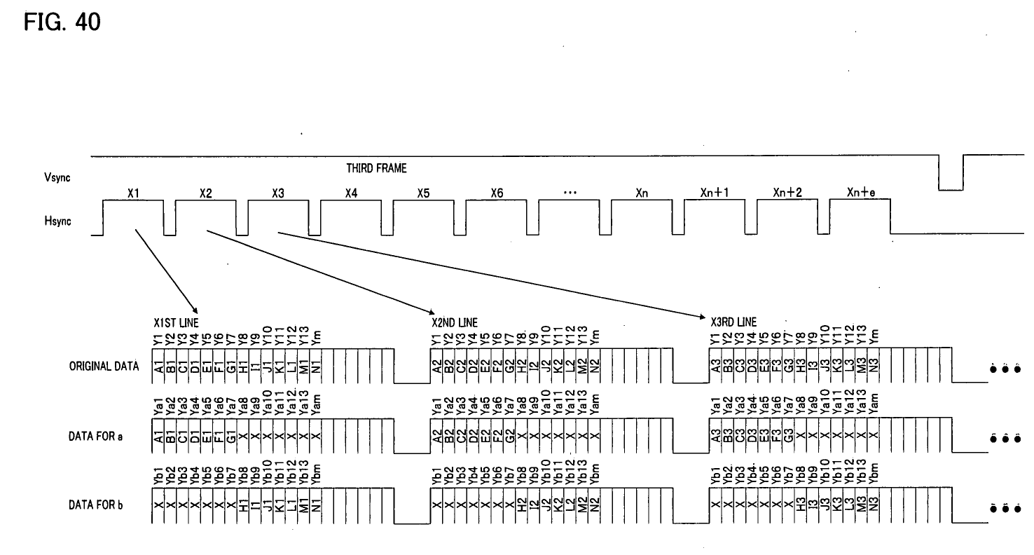

FIGS. 36, 38, and 40 are timing charts showing timing at which the voltages are applied to the liquid crystal panels a and b for the respective frames. FIG. 36 is a timing chart during a first frame; FIG. 38 is a timing chart during a second frame; and FIG. 40 is a timing chart during a third frame.

During the first frame, as shown in FIG. 35, voltages for displaying an image are set for a group of pixel electrodes corresponding to the source electrodes Ya1 through Ya7 of the liquid crystal panel a, and the voltage for a white display (X) is set for a group of pixel electrodes corresponding to the source electrodes Ya8 through Yam of the liquid crystal panel a. Conversely, the voltage for a white display (X) is set to a group of pixel electrodes corresponding to the source electrodes Ya1 through Ya7 of the liquid crystal panel b, while voltages for the display image are set to a group of pixel electrodes corresponding to the source electrodes Ya8 through Yam of the liquid crystal panel b.

As shown in FIG. 36, during the first frame, (i) data for the liquid crystal panel a (data for a) and (ii) data for the liquid crystal panel b (data for b) are separated from original data for displaying the composite display image for every group of pixel electrodes, in accordance with timing of a vertical synchronization signal Vsync and a horizontal synchronization signal Hsync, and are then supplied to the liquid crystal panels, respectively.

In the case of the above display control, during the first frame, the group of pixel electrodes of both of the liquid crystal panels a and b which group of pixel electrodes contribute to a white display are in the refreshment state.

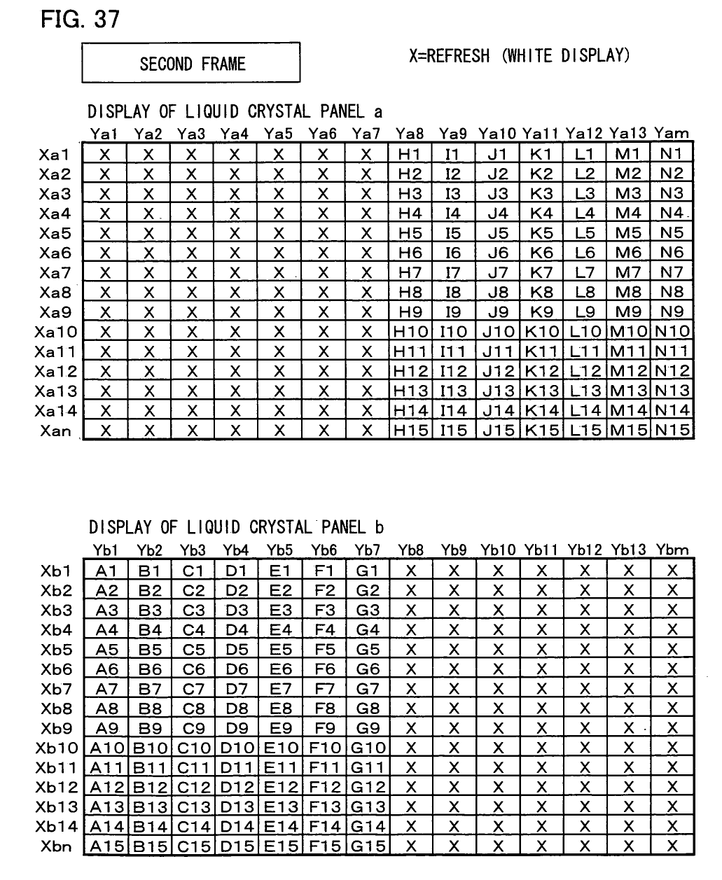

Subsequently, during the second frame, as opposed to the first frame, as shown in FIG. 37, the voltage for the composite display image is set to the group of pixel electrodes of the liquid crystal panel a, to which group of pixel electrodes the voltage for a white display is applied during the first frame. Similarly, the voltage for the composite display image is set to the group of pixel electrodes of the liquid crystal panel b, to which group of pixel electrodes the voltage for a white display is applied during the first frame. As a result, when the display images of the liquid crystal panels a and b are composed, the same composite display image as in the first frame is displayed.

As shown in FIG. 38, during the second frame, the original data for displaying the composite display image is separated into (i) data for the liquid crystal panel a (data for a) and (ii) data for the liquid crystal panel b (data for b), and such data are supplied, in reverse to the first frame, to the respective liquid crystal panels, in accordance with timing of a vertical synchronization signal Vsync and a horizontal synchronization signal Hsync.

In the case of the above display control, during the second frame, similarly to the first frame, the source lines of both of the liquid crystal panels a and b which source lines contribute to a white display are in the refreshment state.

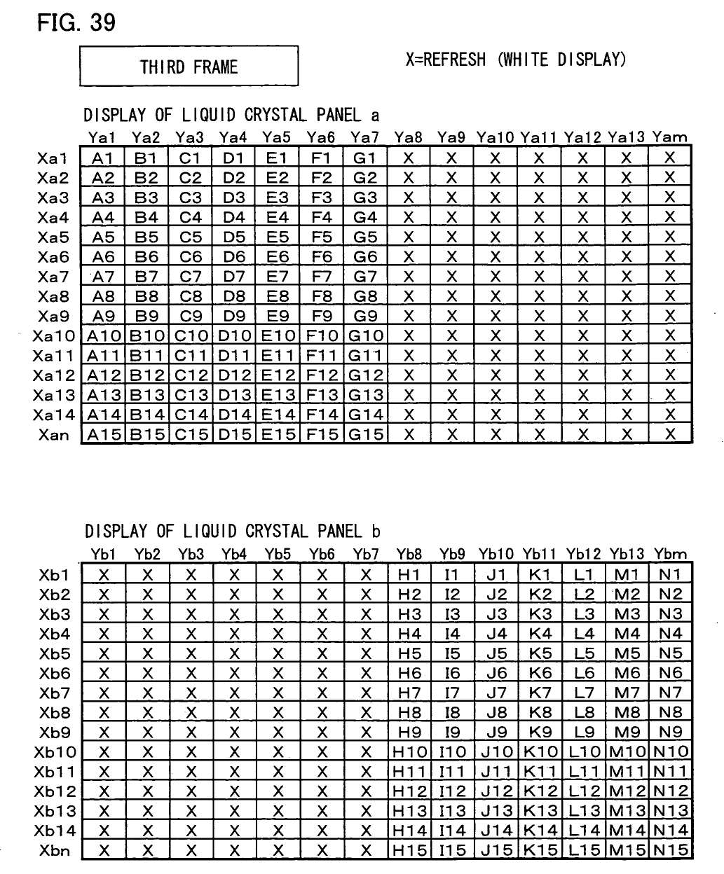

Subsequently, during the third frame, as shown in FIGS. 39 and 40, the liquid crystal panels a and b are in display states identical to those in the first frame.

It is possible for one region of both of the liquid crystal panels to be surely in a refreshment state, by similarly switching the display states of the liquid crystal panels a and b for every frame, e.g., for a fourth frame and for a fifth frame.

The above description deals with a control in which the voltages for a composite display image and the voltage for a white display are applied to the source lines of the liquid crystal panels. The following description deals with a control in which the voltages for a composite display image and the voltage for a white display are applied to the gate lines of the liquid crystal panels.

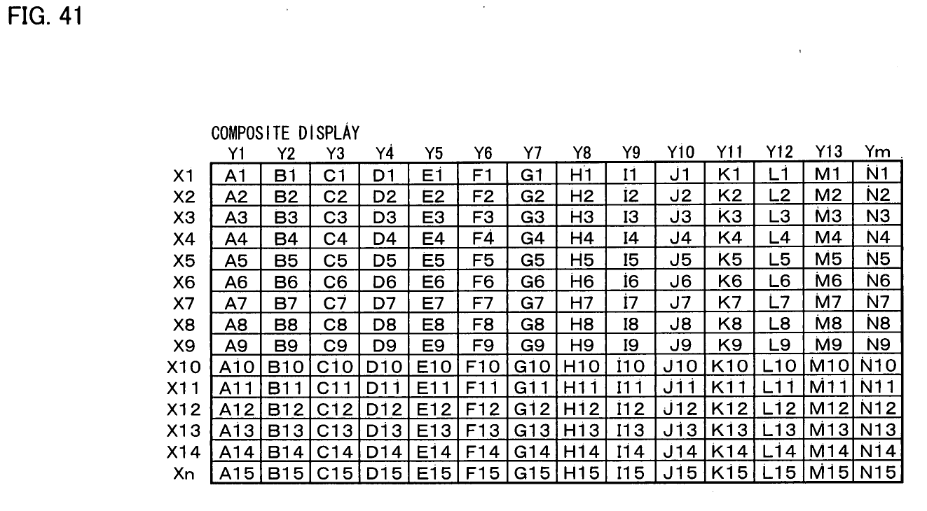

Similarly to FIG. 12, FIG. 41 shows a composite display image, where X1 through Xn refer to gate electrodes, and Y1 through Ym refer to source electrodes. When display voltages are set for pixel electrodes provided so as to correspond to intersections of the electrodes, respectively, the intersections are assigned reference symbols such as A1 and A2.

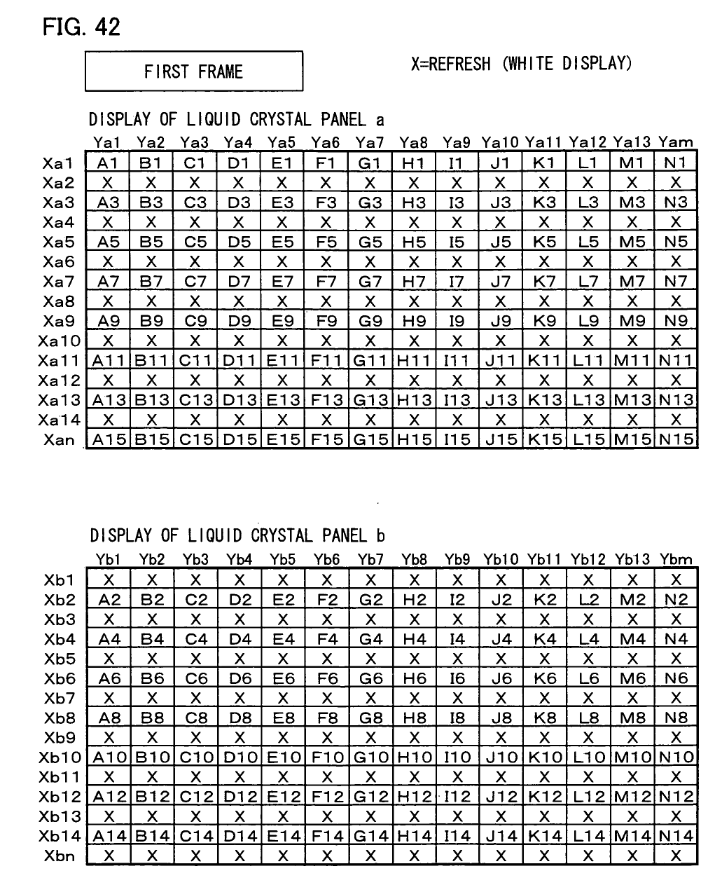

FIGS. 42, 44, and 46 show display states of the liquid crystal panels a and b for respective frames. The X assigned to each of the pixel electrodes indicates that a voltage for a white display is set. The white display in this case is intended to mean a white display that is carried out when it does not have relation to the image to be displayed. As described above, in the case of using liquid crystal panels of the normally white type, a white display is carried out by applying no voltage. Therefore, a voltage of about 0 (or a voltage that causes an alignment of the liquid crystal not to be changed) is set to the pixel electrodes indicated by “X”. In the case of using liquid crystal panels of the normally black type, a white display is carried out by applying a voltage. Therefore, a predetermined voltage is set to the pixel electrodes indicated by “X”. Note that a voltage, causing a white display to be carried out, is set for the pixel electrodes indicated by “X”, in accordance with a display mode.

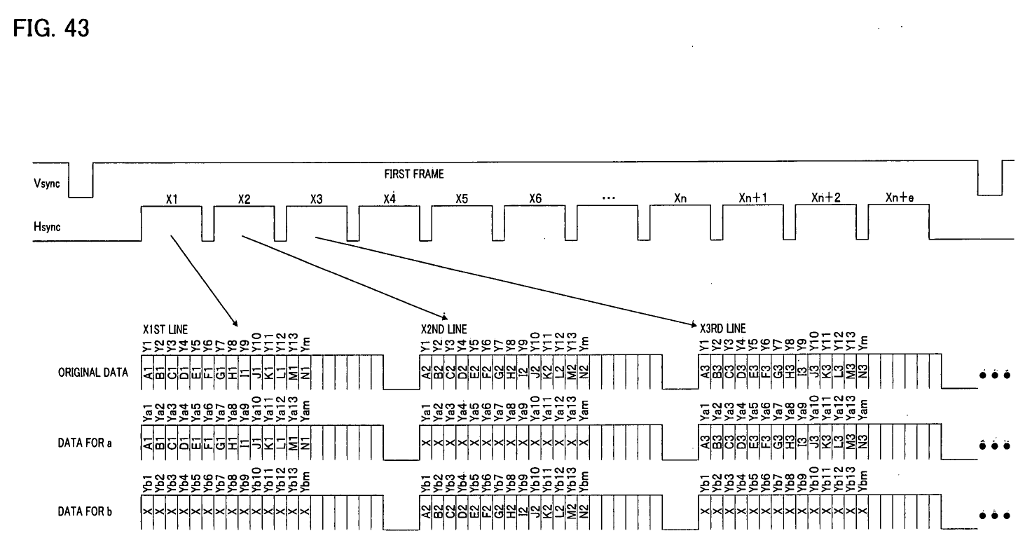

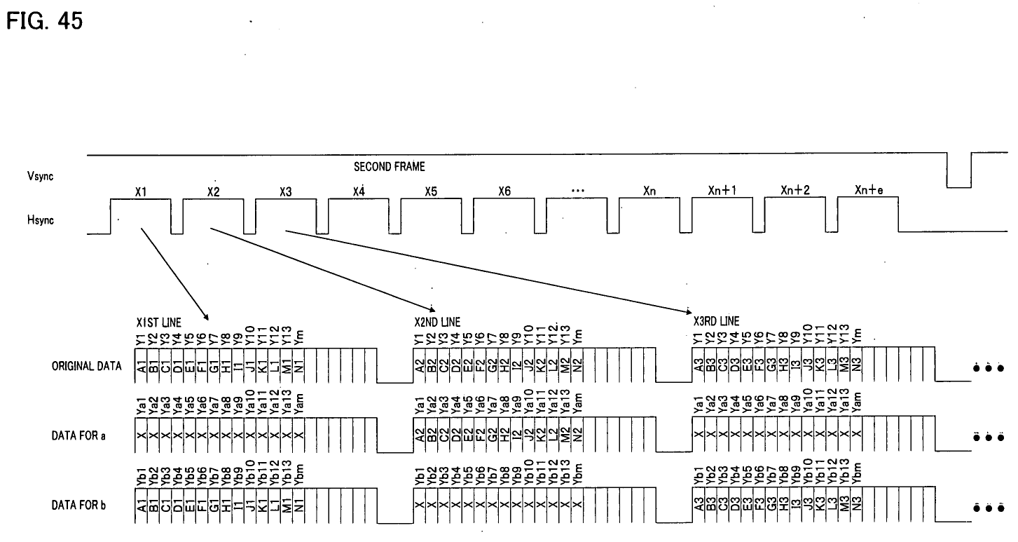

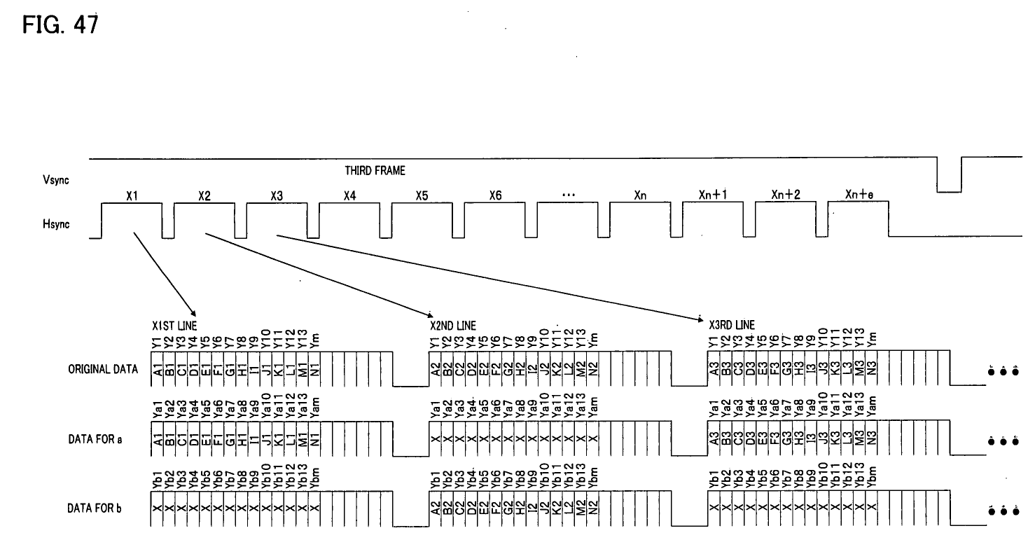

FIGS. 43, 45, and 47 are timing charts showing timing at which the voltages are applied to the liquid crystal panels a and b for the respective frames. FIG. 43 is a timing chart during a first frame; FIG. 45 is a timing chart during a second frame; and FIG. 47 is a timing chart during a third frame.

During the first frame, as shown in FIG. 42, voltages for displaying an image and a voltage for a white display (X) are set alternately for the gate lines of the liquid crystal panels a and b. The voltage for a white display is set for gate lines of the liquid crystal panel b, which gate lines correspond to gate lines of the liquid crystal panel a and for which gate lines voltages identical with the voltage for the composite display image are set. Similarly, the voltage for a white display is set for gate lines of the liquid crystal panel a, which gate lines correspond to gate lines of the liquid crystal panel b and for which gate lines voltages identical with the voltage for the composite display image are set.

As shown in FIG. 43, during the first frame, (i) data for the liquid crystal panel a (data for a) and (ii) data for the liquid crystal panel b (data for b) are separated from original data for displaying the composite display image for every gate line, in accordance with timing of a vertical synchronization signal Vsync and a horizontal synchronization signal Hsync, and are then supplied to the liquid crystal panels, respectively.

In the case of the above display control, during the first frame, the gate lines of both of the liquid crystal panels a and b which gate lines contribute to a white display are in the refreshment state.

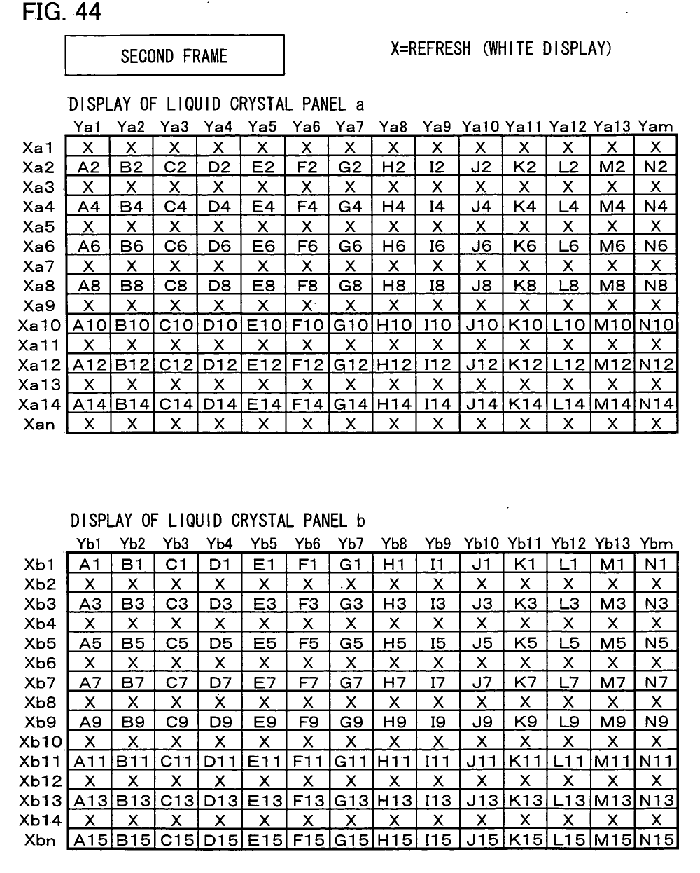

Subsequently, during the second frame, as opposed to the first frame, as shown in FIG. 44, the voltage for the composite display image is set to the gate lines of the liquid crystal panel a, to which gate lines the voltage for a white display is applied during the first frame. Similarly, the voltage for the composite display image is set to the gate lines of the liquid crystal panel b, to which gate lines the voltage for a white display is applied during the first frame. As a result, when the display images of the liquid crystal panels a and b are composed, the same composite display image as in the first frame is displayed.

As shown in FIG. 45, during the second frame, (i) data for the liquid crystal panel a (data for a) and (ii) data for the liquid crystal panel b (data for b) are separated from original data for displaying the composite display image for every source line, in accordance with timing of a vertical synchronization signal Vsync and a horizontal synchronization signal Hsync, and are then supplied to the liquid crystal panels, conversely to the first frame.

In the case of the above display control, during the second frame, similarly to the first frame, the source lines of both of the liquid crystal panels a and b which source lines contribute to a white display are in the refreshment state.

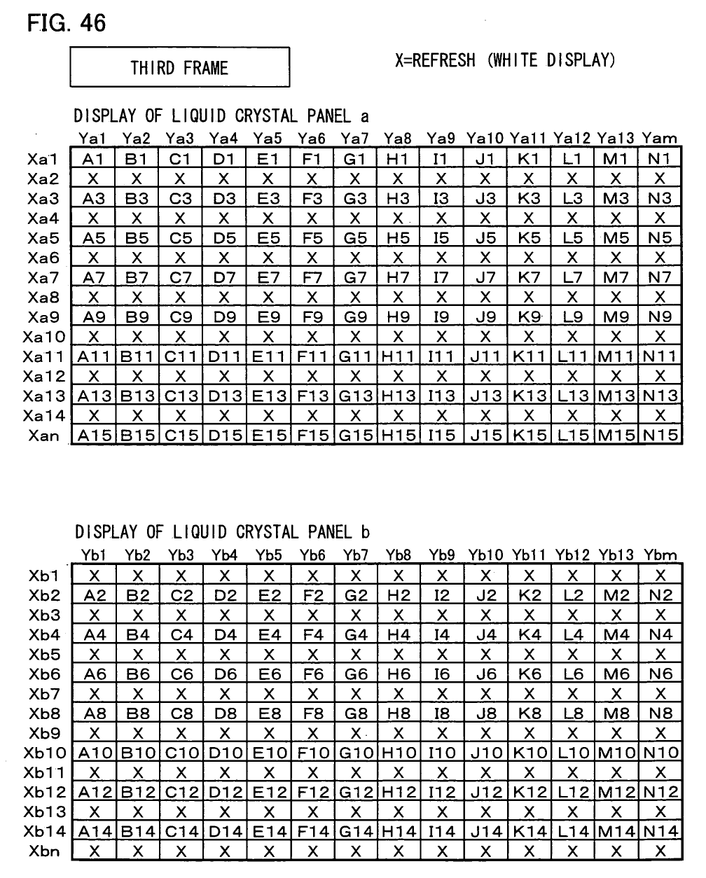

Subsequently, during the third frame, as shown in FIGS. 46 and 47, the liquid crystal panels a and b show display states identical to those during the first frame.

It is possible for one region of both of the liquid crystal panels to be surely in a refreshment state, by similarly switching the display states of the liquid crystal panels a and b for every frame, e.g., for a fourth frame and for a fifth frame.

### Embodiment 3

The following description deals with a further embodiment of the present invention. Note that same members in the present embodiment as those in Embodiment 1 are assigned the same reference codes and the description of the members is omitted.

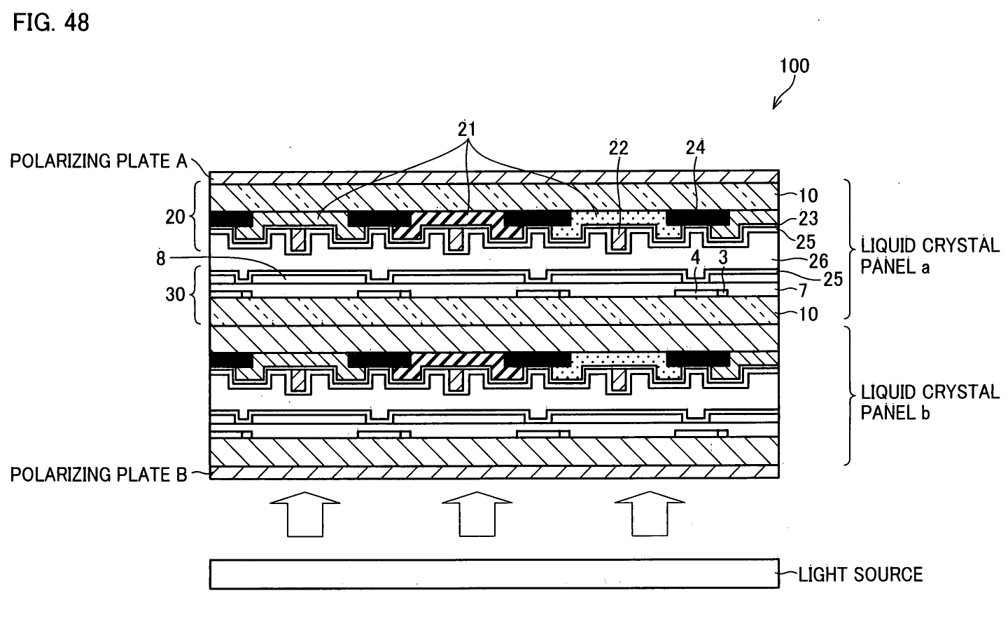

As shown in FIG. 48, a liquid crystal display device 100 of the present embodiment has a substantially the same arrangement as that of the liquid crystal display device 100 shown in FIG. 1 but is different in that no polarizing plate is provided between liquid crystal panels a and b. Since it is possible to omit one polarizing plate, it is advantageous in terms of costs.

The liquid crystal display device 100 of the present embodiment basically operates in substantially the same manner as Embodiment 1. However, it should be noted that the terms such as “white display” and “black display” of each of the liquid crystal panels refer to conceptual contents. Specifically, it should be understood that the terms “white display” and “black display” of each of the panels refer to a state in which a signal, allowing an image displayed in a case where a polarizing plate is provisionally provided on a front side or on a rear side of each of the panels to express white or black, is supplied to each of the panels.

Similarly to Embodiment 1, it is preferable to provide a light diffusion layer, either between the panels or on a front surface of the polarizing plate provided on a front side. This is because interference of pixels of the liquid crystal panels a and b may cause a moire image.

Described first is the case in which a panel is used in which an individual combination of each of the liquid crystal panels and a pair of polarizing plates by which the liquid crystal panel is sandwiched, carries out a normally black (NB) display.

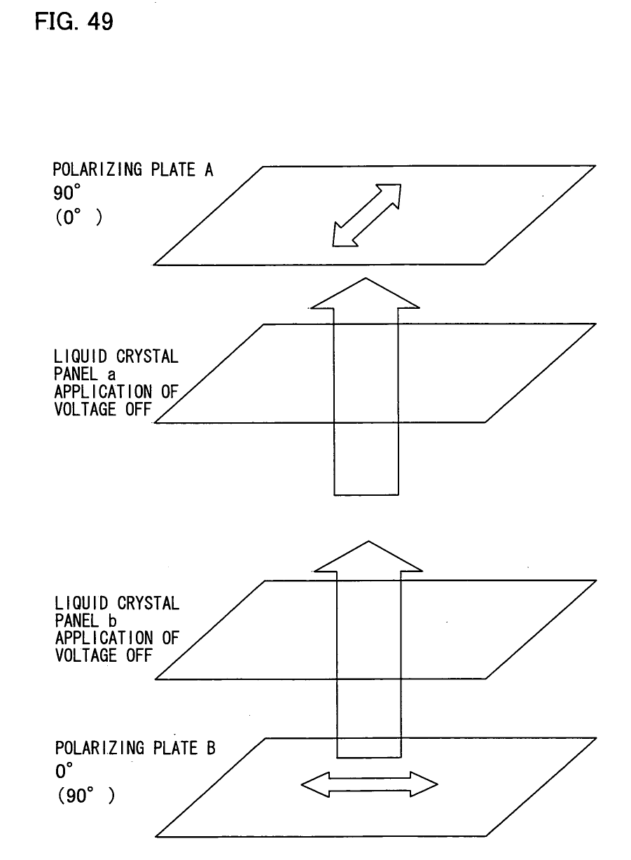

FIG. 49 is an explanatory diagram showing a state in which no voltage is applied to each of the liquid crystal panels when a liquid crystal panel of a vertical alignment type such as the MVA mode is used as each of the liquid crystal panels. Specifically, since liquid crystal molecules of the MVA mode are aligned vertically to the substrates when no voltage is applied (a voltage to be applied is off), the liquid crystal panels a and b are arranged so that incident light is gone out without being skewed.

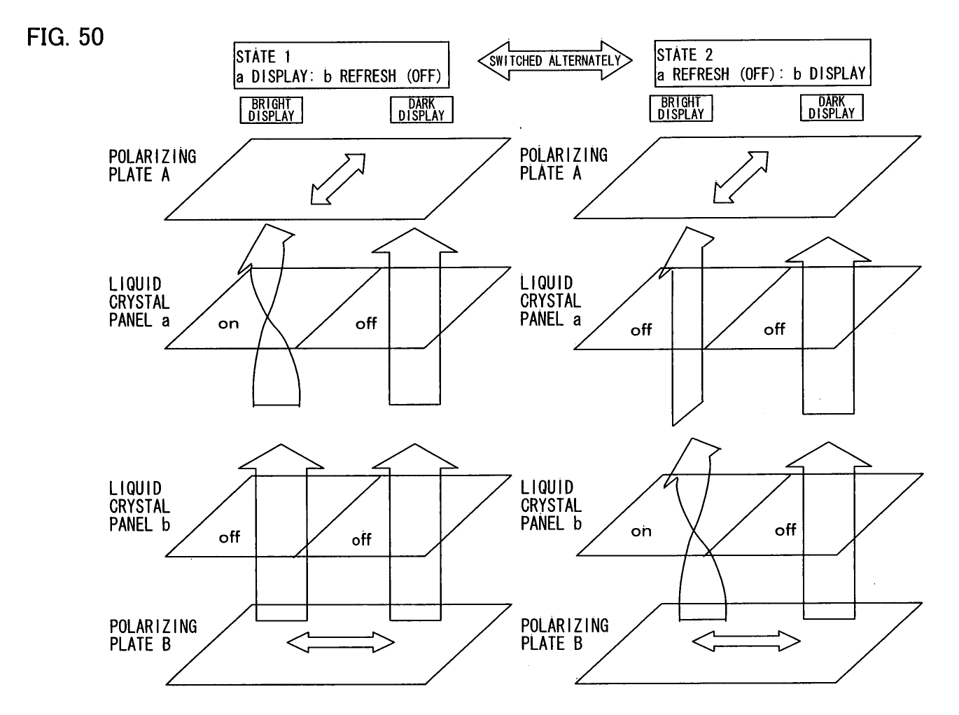

FIG. 50 is an explanatory diagram illustrating a switching of the display states obtained in the case of the MVA mode as shown in FIG. 49. FIG. 50 shows, for convenience of explanation, a case in which an image, combined by display images of the liquid crystal panels a and b, is a black-and-white image which has divided bright and dark display regions.

As shown in FIG. 50, in State 1, one of two display regions of the liquid crystal panel a is set in the ON state, while a voltage is applied to pixel electrodes corresponding to the one of the display region, whereas the other of the two display regions is set in the OFF state, while no voltage is applied to pixel electrodes corresponding to the other of the display regions. The liquid crystal molecules in the display region in the ON state are slanted either 45 degrees or −45 degrees with respect to the absorption axes of the polarizing plates, respectively. No voltage is applied to pixel electrodes in both of two display regions of the liquid crystal panel b which display regions correspond to the two display regions of the liquid crystal panel a, respectively, so that the liquid crystal panel b is in the OFF state.

This causes light which has passed through the polarizing plate B not to be skewed in and to pass through the two display regions of the liquid crystal panel b, and is then entered into the liquid crystal panel a. Part of the light is entered into one of the display regions of the liquid crystal panel a, while a voltage is applied to the pixel electrodes corresponding to the one of the display regions so that the one of display regions is in the ON state. The part of the light is skewed by about 90 degrees, and is directed toward the polarizing plate A. When the light which has been skewed by 90 degrees in the liquid crystal panel a passes through the polarizing plate A, a bright display is carried out. This is because the polarizing plate A has a polarizing absorption axis that is perpendicular to a polarizing absorption axis of the polarizing plate B. Another part of the outgoing light from the polarizing plate C is entered into the other one of the display regions of the liquid crystal panel a, while no voltage is applied to the pixel electrodes corresponding to the other one of the display regions so that the other one of the display region is in the OFF state. The other part of the outgoing light is, without being skewed, directed toward the polarizing plate A. Since the polarizing absorption axis of the polarizing plate A is perpendicular to the polarizing absorption axis of the polarizing plate B, the light which has passed through the liquid crystal panel b without being skewed is incapable of passing through the polarizing plate A. This causes a dark display to be carried out.

According to the state 1, (i) since the display state of the liquid crystal panel a corresponds to the display state of a composite image, the liquid crystal panel a is in a state of carrying out a display, and (ii) since the display state of the liquid crystal panel b is different from the display state of the composite image, the liquid crystal panel b is in the refreshment (OFF) state. The refreshment (OFF) state refers to a state in which a liquid crystal panel carries out a display that does not have direct relation to a display corresponding to a video image source while no voltage is applied to the pixel electrodes of the liquid crystal panel so that phosphor burn-in of the liquid crystal panel is prevented.

State 2 shown in FIG. 50 shows a state reverse to the state 1. Specifically, it is assumed that no voltage is applied to the pixel electrodes corresponding to the two display regions of the liquid crystal panel a, respectively, so that the liquid crystal panel a is in the OFF state. On the other hand, it is assumed that a voltage is applied to the pixel electrodes corresponding to one of the two display regions of the liquid crystal panel b so that the one of the display region is in the ON state, whereas no voltage is applied to the pixel electrodes corresponding to the other one of the display regions is in the OFF state.

This causes part of light which has passed through the polarizing plate B is entered into one of the two display regions of the liquid crystal panel b, while a voltage is applied to the pixel electrodes corresponding to the one of the display regions so that the one of the display regions is in the ON state. The part of the light is skewed by 90 degrees in and passes through the one of the display regions. The part of the light is then entered into a display region of the liquid crystal panel a, while no voltage is applied to the pixel electrodes corresponding to the display region so that the display region is in the OFF state. The light which has been entered into the display region of the liquid crystal panel a is without being skewed by 90 degrees, directed toward the polarizing plate A. Since the polarizing absorption axis of the polarizing plate A is perpendicular to the polarizing absorption axis of the polarizing plate C, the light which has been skewed by 90 degrees once in the liquid crystal panel b passes through the polarizing plate A. This causes a bright display to be carried out. Another part of the light which part has been entered into the other one of the display regions of the liquid crystal panel b which one of the display regions is in the OFF state is, without being skewed, directed toward the display region of the liquid crystal panel a which display region is in the OFF state. The light which has been entered into the display region of the liquid crystal panel a which display region is in the OFF state is, without being skewed by 90 degrees, directed toward the polarizing plate A. Since the polarizing plate A has a polarizing absorption axis that is perpendicular to the polarizing absorption axis of the polarizing plate B, the light which has passed through the polarizing plate B and never been skewed is incapable of passing through the polarizing plate A. This causes a dark display to be carried out.

According to the state 2, (i) since the display state of the liquid crystal panel b corresponds to the display state of a composite image, the liquid crystal panel b is in a state of carrying out a display, and (ii) since the display state of the liquid crystal panel a is different from the display state of the composite image, the liquid crystal panel a is in the refreshment (OFF) state.

In the OFF state, the voltage applied to the pixels may be set at 0, or a voltage which is inadequate to change an alignment of the liquid crystal may be applied.

The states 1 and 2 shown in FIG. 50 display an identical image. Thus, even when an identical image is continuously displayed, by alternately switching between the states 1 and 2, it is possible to always refresh any one of the liquid crystal panels at any given time. This allows prevention of phosphor burn-in in the liquid crystal panels.

Other display modes applicable to the present embodiment are the Patterned Vertical Alignment (PVA) mode and the IPS mode. The PVA is a type in which a slit in the electrode is used in place of the alignment control projection used in the MVA. FIGS. 7(a) and 7(b) are schematic cross-sectional views showing the PVA mode. An alignment film in use is a vertical alignment film. A liquid crystal in use is a liquid crystal having a negative dielectric anisotropy. FIG. 7(a) shows a state in which liquid crystal molecules lie vertically while no voltage is applied. FIG. 7(b) shows a state in which a voltage is applied and a direction in which the liquid crystal is slanted is defined with use of an oblique electric field caused by the slit in the electrode. The angle of a polarizing plate in MVA is similarly applicable to PVA.

Further, according to the IPS mode, a liquid crystal is twisted within a plane parallel to the substrates, by applying an electric field parallel to the substrates. FIGS. 8(a) through 8(d) are explanatory views schematically illustrating the IPS mode. FIGS. 8(a) and 8(b) are schematic cross-sectional views, and FIGS. 8(c) and 8(d) are schematic cross-sectional views of a pixel. According to the IPS mode, a horizontal alignment film and, generally, a crystal liquid having a positive dielectric anisotropy are used. FIGS. 8(a) and 8(c) show a state in which the liquid crystal molecules lie in a rubbing direction of the horizontal alignment film (not shown) while no voltage is applied. FIGS. 8(b) and 8(d) show a state in which a voltage is applied, and the alignment direction of the liquid crystal is rotated by approximately 45 degrees in a horizontal plane by a lateral electric field generated by electrodes having a comb-teeth shape. Unlike other modes, a counter substrate does not have an electrode. The polarizing plates on both sides are arranged so as to be at angles of 0 degree and 90 degrees with respect to the rubbing direction, respectively. When no voltage is applied to the pixel electrodes, the liquid crystal molecules lie at an angle of 0 degrees or 90 degrees with respect to the polarizing axes. Since no influence of birefringence of the liquid crystal is caused. A polarization direction of a polarized light, which is caused by light which has entered the polarizing plate provided on the side facing a light source, is not rotated and is therefore blocked by the polarizing plate provided on an emitting side, and thereby a dark display is carried out. When a voltage is applied so that the liquid crystal molecules lie at an angle of 45 degrees or −45 degrees with respect to the polarizing axes, the polarization direction is rotated, and thereby a dark display is carried out. Modifications of the IPS mode exemplified by a mode in which electrodes are provided so as to have an L shape, and a mode in which (i) upper and lower electrodes by which an insulating film is sandwiched are provided and the lower electrode is provided to be solid within each of the pixels so that a fringe field is generated.

The following description deals with a case where a panel is used in which an individual combination of a liquid crystal panel and a pair of polarizing plates by which the liquid crystal panel is sandwiched carries out a normally white (NW) display.

The NW type is represented by the Twisted Nematic (TN) type. FIGS. 9(a) and 9(b) are explanatory cross-sectional views schematically illustrating the TN type. FIG. 9(a) shows a state in which no voltage is applied and a rubbing is carried out to horizontal alignment films (not shown) so that liquid crystal molecules are twisted by approximately 90 degrees. The polarizing plates are provided parallel to rubbing directions of the alignment films of the upper and lower substrates, respectively. The axes of the polarizing plates are perpendicular to each other. A polarization direction of incident polarized light is rotated by 90 degrees in accordance with the twist of the liquid crystal molecules, and the light thus polarized passes through the polarizing plate provided on an outgoing side. This causes a bright display to be carried out. FIG. 9(b) shows a state in which a voltage is applied and the liquid crystal molecules lie vertically to the substrates when the liquid crystal having a positive dielectric anisotropy is used. In this case, polarized light changes very little its polarization direction, and therefore the polarized light does not pass through the polarizing plate provided on the outgoing side. This causes a dark display to be carried out.

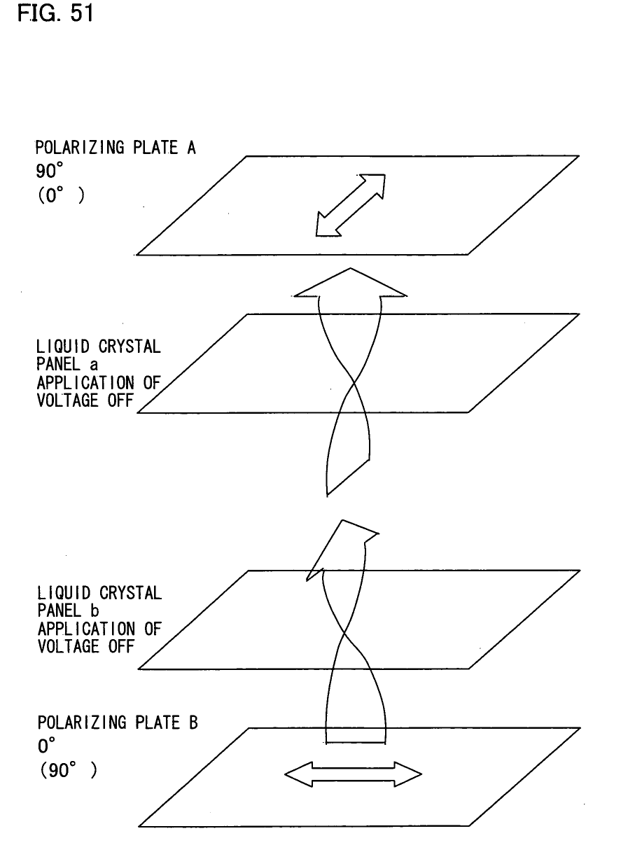

FIG. 51 is a view showing a state in which, when each of the liquid crystal panels is of a TN liquid crystal, no voltage is applied to each of the liquid crystal panels. The absorption axes of the polarizing plates A and B are perpendicular to each other. The absorption axes of the polarizing plates A and B are provided so as to lie at an angle of 90 degrees or 0 degrees with respect to the rubbing directions, respectively. An alignment direction of the liquid crystal is twisted 90 degrees in the liquid crystal panels when no voltage is applied. In other words, according to the TN type, when no voltage is applied (a voltage to be applied is off), light which is entered into either of the liquid crystal panels a and b is skewed 90 degrees and sent out.

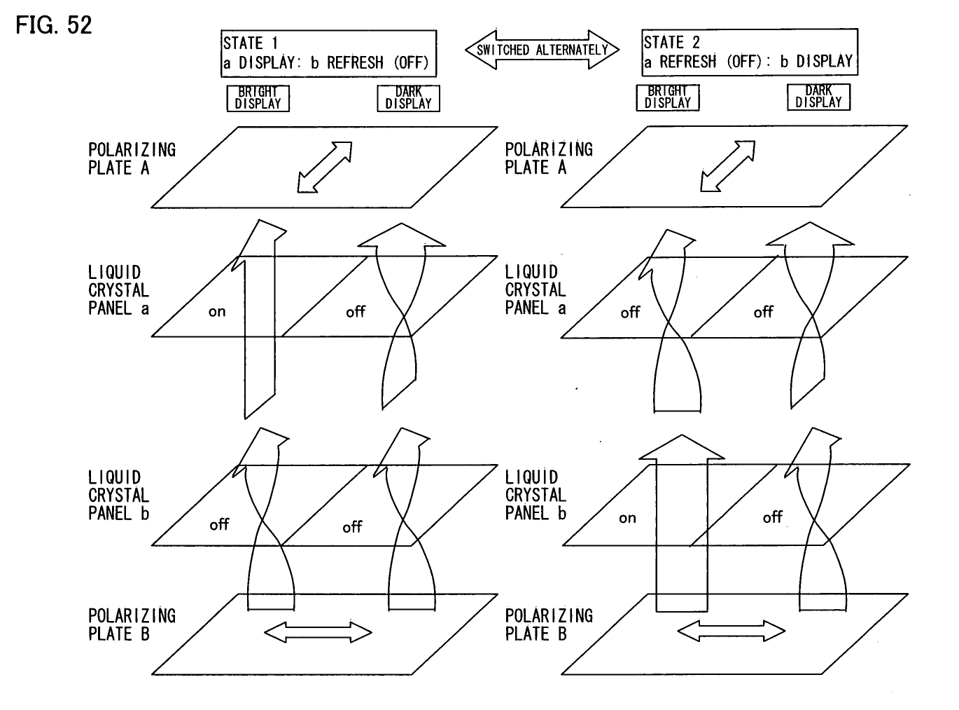

FIG. 52 is an explanatory diagram illustrating a switching of the display states (states 1, 2) obtained in the case of the TN type as shown in FIG. 51. FIG. 52 shows, for convenience of explanation, a case in which an image, combined by display images of the liquid crystal panels a and b, is a black-and-white image which has divided bright and dark display regions.

In state 1 shown in FIG. 52, one of two display regions of the liquid crystal panel a is set in the OFF state in which no voltage is applied to pixel electrodes corresponding to one of the two display regions, whereas the other of the two display regions is set in the ON state in which a voltage is applied to pixel electrodes corresponding to the other one of the two display regions. The liquid crystal panel b is set in the OFF state while no voltage is applied to pixel electrodes corresponding to both of two display regions which correspond to the two display regions of the liquid crystal panel a.

This causes light which has passed through the polarizing plate B to be skewed by 90 degrees in and to pass through the two display regions of the liquid crystal panel b, and is then entered into the liquid crystal panel a. Part of the light is entered into one of the display regions of the liquid crystal panel a, while no voltage is applied to the pixel electrodes corresponding to the one of the display regions so that the one of display regions is in the OFF state. The part of the light is further skewed by 90 degrees during passing through the liquid crystal panel a, and is directed toward the polarizing plate A. When the light which has further been skewed by 90 degrees once in the liquid crystal panel a is incapable of passing through the polarizing plate A, a dark display is carried out. This is because the polarizing plate A has a polarizing absorption axis that is perpendicular to a polarizing absorption axis of the polarizing plate B. Another part of the light from the liquid crystal panel b is entered into the other one of the display regions of the liquid crystal panel a, while a voltage is applied to the pixel electrodes corresponding to the other one of the display regions so that the other one of the display region is in the ON state. The other part of the outgoing light is, without being skewed, directed toward the polarizing plate A. Since the polarizing absorption axis of the polarizing plate A is perpendicular to the polarizing absorption axis of the polarizing plate B, the light which has passed through the polarizing plate B and been skewed by 90 degrees once passes through the polarizing plate A. This causes a bright display to be carried out.

According to the state 1, (i) since the display state of the liquid crystal panel a corresponds to the display state of a composite image, the liquid crystal panel a is in a state of carrying out a display, and (ii) since the display state of the liquid crystal panel b is different from the display state of the composite image, the liquid crystal panel b is in the refreshment (OFF) state. The refreshment (OFF) state refers to a state in which a liquid crystal panel carries out a display that does not have direct relation to a display corresponding to a video image source while no voltage is applied to the pixel electrodes of the liquid crystal panel so that accumulation of an electric charge caused by a DC component in the liquid crystal panel is prevented, i.e., phosphor burn-in of the liquid crystal panel is prevented. When causing a liquid crystal panel to be in a refreshment state, it is possible to apply a low voltage (a voltage for a whitish tone) to the pixel electrodes.

State 2 shown in FIG. 52 shows a state reverse to the state 1. Specifically, it is assumed that no voltage is applied to the pixel electrodes corresponding to the two display regions of the liquid crystal panel a, respectively, so that the liquid crystal panel a is in the OFF state. On the other hand, it is assumed that no voltage is applied to the pixel electrodes corresponding to one of the two display regions of the liquid crystal panel b so that the one of the display region is in the OFF state, whereas a voltage is applied to the pixel electrodes corresponding to the other one of the display regions so that the other one of the display regions is in the ON state.

This causes part of light which has passed through the polarizing plate B is entered into one of the two display regions of the liquid crystal panel b, while no voltage is applied to the pixel electrodes corresponding to the one of the display regions so that the one of the display regions is in the OFF state. The part of the light is skewed by about 90 degrees in and passes through the one of the display regions. The part of the light is then entered into one of the display regions of the liquid crystal panel a, while no voltage is applied to the pixel electrodes corresponding to the display region so that the display region is in the OFF state. The light is skewed by 90 degrees in the one of the display regions, and directed toward the polarizing plate A. Since the polarizing absorption axis of the polarizing plate A is perpendicular to the polarizing absorption axis of the polarizing plate B, the light which has further been skewed by 90 degrees in the liquid crystal panel b is incapable of passing through the polarizing plate A. This causes a dark display to be carried out. Another part of the light which part has been entered into the other one of the display regions of the liquid crystal panel b which one of the display regions is in the ON state is, without being skewed, directed toward the display region of the liquid crystal panel a which display region is in the OFF state. The light which has been entered into the display region of the liquid crystal panel a which region is in the OFF state is skewed 90 degrees and directed toward the polarizing plate A. Since the polarizing plate A has a polarizing absorption axis that is perpendicular to the polarizing absorption axis of the polarizing plate B, the light which has passed the polarizing plate B and been skewed 90 degrees once passes through the polarizing plate A. This causes a bright display to be carried out.

According to the state 2, (i) since the display state of the liquid crystal panel b corresponds to the display state of a composite image, the liquid crystal panel b is in a state of carrying out a display, and (ii) since the display state of the liquid crystal panel a is different from the display state of the composite image, the liquid crystal panel a is in the refreshment (OFF) state.

In the OFF state, the voltage applied to the pixels may be set at 0, or a voltage which is inadequate to change an alignment of the liquid crystal may be applied.

The states 1 and 2 shown in FIG. 52 display an identical image. Thus, even when an identical image is continuously displayed, by alternately switching between the states 1 and 2, it is possible to always refresh any one of the liquid crystal panels at any given time. This allows prevention of phosphor burn-in in the liquid crystal panels.

The above description in the present embodiment deals with the refreshment (off) in which either no voltage or a low voltage for a whitish tone is applied so that the liquid crystal panels are refreshed, in the case where the liquid crystal display mode of an individual liquid crystal panel in the liquid crystal display device 100 having the above arrangement is a normally white (NW) display. Alternatively, when the liquid crystal panel is refreshed, the refreshing (on) may be performed by applying a voltage that is higher than the voltage for displaying a whitish tone.

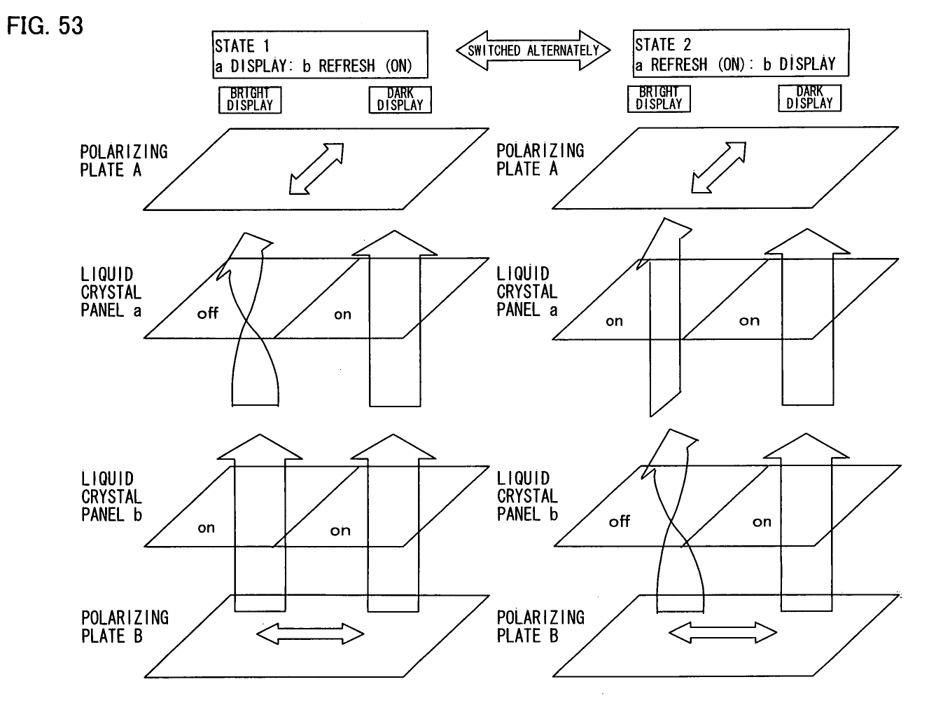

This is dealt with by the following description with reference to FIG. 53.

FIG. 53 is an explanatory diagram illustrating a switching of the display states obtained in the case of the NW type (e.g., the TN type) as shown in FIG. 51. FIG. 53 shows, for convenience of explanation, a case in which an image, combined by display images of the liquid crystal panels a and b, is a black-and-white image which has divided bright and dark display regions.

In state 1 shown in FIG. 52, one of two display regions of the liquid crystal panel a is set in the OFF state in which no voltage is applied to pixel electrodes corresponding to one of the two display regions, whereas the other of the two display regions is set in the ON state in which a voltage is applied to pixel electrodes corresponding to the other one of the two display regions. The liquid crystal panel b is set in the ON state while a voltage is applied to pixel electrodes corresponding to both of two display regions which correspond to the two display regions of the liquid crystal panel a.

This causes light which has passed through the polarizing plate B not to be skewed in and to pass through the two display regions of the liquid crystal panel b, and is then entered into the liquid crystal panel a. Part of the light is entered into one of the display regions of the liquid crystal panel a, while no voltage is applied to the pixel electrodes corresponding to the one of the display regions so that the one of display regions is in the OFF state. The part of the light is skewed by 90 degrees during passing through the liquid crystal panel a, and is directed toward the polarizing plate A. When the light which has been skewed by 90 degrees once in the liquid crystal panel a passes through the polarizing plate A, a bright display is carried out. This is because the polarizing plate A has a polarizing absorption axis that is perpendicular to a polarizing absorption axis of the polarizing plate B. Another part of the light from the liquid crystal panel b is entered into the other one of the display regions of the liquid crystal panel a, while a voltage is applied to the pixel electrodes corresponding to the other one of the display regions so that the other one of the display region is in the ON state. The other part of the outgoing light is, without being skewed, directed toward the polarizing plate A. Since the polarizing absorption axis of the polarizing plate A is perpendicular to the polarizing absorption axis of the polarizing plate B, the light which has passed through the polarizing plate B and never been skewed is incapable of passing through the polarizing plate A. This causes a dark display to be carried out.

According to the state 1, (i) since the display state of the liquid crystal panel a corresponds to the display state of a composite image, the liquid crystal panel a is in a state of carrying out a display, and (ii) since the display state of the liquid crystal panel b is different from the display state of the composite image, the liquid crystal panel b is in the refreshment (ON) state. The refreshment (ON) state refers to a state in which a liquid crystal panel carries out a display that does not have direct relation to a display corresponding to a video image source while a voltage is applied to the pixel electrodes of the liquid crystal panel so that phosphor burn-in of the liquid crystal panel is prevented.

State 2 shown in FIG. 53 shows a state reverse to the state 1. Specifically, it is assumed that a voltage is applied to the pixel electrodes corresponding to the two display regions of the liquid crystal panel a, respectively, so that the liquid crystal panel a is in the ON state. On the other hand, it is assumed that no voltage is applied to the pixel electrodes corresponding to one of the two display regions of the liquid crystal panel b so that the one of the display region is in the OFF state, whereas a voltage is applied to the pixel electrodes corresponding to the other one of the display regions so that the other one of the display regions is in the ON state.

This causes part of light which has passed through the polarizing plate B is entered into one of the two display regions of the liquid crystal panel b, while no voltage is applied to the pixel electrodes corresponding to the one of the display regions so that the one of the display regions is in the OFF state. The part of the light is skewed by about 90 degrees in and passes through the one of the display regions. The part of the light is then entered into one of the display regions of the liquid crystal panel a, while a voltage is applied to the pixel electrodes corresponding to the display region so that the display region is in the ON state. The light is, without being skewed 90 degrees, directed toward the polarizing plate A. Since the polarizing absorption axis of the polarizing plate A is perpendicular to the polarizing absorption axis of the polarizing plate B, the light which has been skewed by 90 degrees once in the liquid crystal panel b is incapable of passing through the polarizing plate A. This causes a bright display to be carried out. Another part of the light which part has been entered into the other one of the display regions of the liquid crystal panel b which one of the display regions is in the ON state is, without being skewed, directed toward the display region of the liquid crystal panel a which display region is in the ON state. The light which has been entered into the display region of the liquid crystal panel a which region is in the ON state is, without being skewed 90 degrees, directed toward the polarizing plate A. Since the polarizing plate A has a polarizing absorption axis that is perpendicular to the polarizing absorption axis of the polarizing plate B, the light which has passed the polarizing plate B and never been skewed 90 degrees is incapable of passing through the polarizing plate A. This causes a dark display to be carried out.

According to the state 2, (i) since the display state of the liquid crystal panel b corresponds to the display state of a composite image, the liquid crystal panel b is in a state of carrying out a display, and (ii) since the display state of the liquid crystal panel a is different from the display state of the composite image, the liquid crystal panel a is in the refreshment (ON) state.

The states 1 and 2 shown in FIG. 53 display an identical image. Thus, even when an identical image is continuously displayed, by alternately switching between the states 1 and 2, it is possible to always refresh any one of the liquid crystal panels at any given time. This allows prevention of phosphor burn-in in the liquid crystal panels.

As described above, according to each of the embodiments, an identical image is displayed with use of two liquid crystal panels, while any one of display regions is refreshed. Therefore, even when an identical image is displayed constantly for an extended period of time, phosphor burn-in is difficult to occur on a display screen of each of the liquid crystal panels. Furthermore, the liquid crystal display device of the present invention is capable of continuously carrying out a display, and therefore is suitable for an electronic device including a display device that is required to continuously display an identical image, such as timetables, advertisements, sign-post, or traffic signs.

For ease of explanation, the above embodiments mainly deal with the case of dark or bright display. However, a display of an intermediate tone can be realized by applying a voltage for causing the pixel electrodes of the panels that carry out a driving in accordance with an image signal to carry out an intermediate liquid crystal alignment. Furthermore, a color display can be carried out with use of a color filter.

Each of the above embodiments deals with the case of two liquid crystal panels combined with each other. However, the present invention is not limited to this. The present invention can also be realized even in a case of three or more liquid crystal panels combined with one another.

Specifically, even in the case of three or more liquid crystal panels, phosphor burn-ins on a display screen can be prevented similarly to the case of two liquid crystal panels, by causing images displayed on the liquid crystal panels to be different from one another so that one image is displayed as a whole, and by switching the display images of each of the liquid crystal panels.

Further, the embodiments deal with the case where display states of the liquid crystal panels optically combined are switched for every frame. However, the case is not limited to this. For example, it is also possible to switch the display states for every half a frame. In this case, although it is required to change the timing clock and add a frame memory, it is possible to reduce flicker in screen that occurs during switching the display states. For example, it is also possible to switch the display states for every predetermined period of time measured with use of a timer provided in the liquid crystal display device. This allows the display states to be switched for every given period of time. In this case, it is also possible to switch the display states for every relatively long period of time, for example, for every 24 hours.

In a case of switching the display states for every relatively long period of time, e.g., for every 24 hours as described above, particularly when only one of the liquid crystal panels is caused to display a desired image as shown in FIGS. 1(a) and 1(b) of Embodiment 1, it is preferable to completely stop a driving of the other one of the liquid crystal panels (the liquid crystal panel which does not contribute to the display). This causes no voltage to be applied to the liquid crystal panel which does not contribute to the display, thereby avoiding that electric charge is accumulated by the liquid crystal panel.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

A liquid crystal display device of the present invention is applicable to a display device which is required to continuously display an identical image, such as a timetable, for an extended period of time.

1. A method for driving a liquid crystal display device, comprising the step of:
when at least two liquid crystal panels, which are combined with one another, display respective images which vary in accordance with a video image source so that an image corresponding to the video image source is displayed by said at least two liquid crystal panels,
replacing the respective images, displayed on said at least two liquid crystal panels, with one another at a preset interval.

2. A liquid crystal display device in which at least two liquid crystal panels, which are combined with one another, display respective images which vary in accordance with a video image source so that an image corresponding to the video image source is displayed by said at least two liquid crystal panels,
said liquid crystal display device comprising:
display signal generating means for generating display signals causing said at least two liquid crystal panels to display the respective images that are different from one another in accordance with the video image source; and
display signal outputting means for switching the display signals, generated by the display signal generating means, with one another for every preset period of time, and for outputting the display signals thus switched to said at least two liquid crystal panels, respectively.

3. A liquid crystal display device in which at least two liquid crystal panels, which are combined with one another, display respective images which vary in accordance with a video image source so that an image corresponding to the video image source is displayed by said at least two liquid crystal panels,
said liquid crystal display device, comprising
display signal generating means for generating display signals causing some of said at least two liquid crystal panels to display images in accordance with the video image source;
display signal outputting means for switching the display signals for every preset period of time, and for outputting the display signals thus switched to ones of said at least two liquid crystal panels except at least one of said at least two liquid crystal panels; and
voltage application controlling means for controlling driving voltages to be respectively applied to said at least two liquid crystal panels,
the voltage application controlling means stopping applying of driving voltages to said at least one of said at least two liquid crystal panels to each of which no display signal is supplied by the display signal outputting means.

4. The liquid crystal display device according to claim 2, wherein said at least two liquid crystal panels consists of first and second liquid crystal panels, and said display signal generating means generates, in accordance with the video image source, display signals that cause (i) the first liquid crystal panel to carry out a display of the image corresponding to the video image source, and (ii) the second liquid crystal panel to carry out a display that does not affect the display carried out by the first liquid crystal panel.

5. The liquid crystal display device according to claim 4, wherein the display signals are ones causing (i) the first liquid crystal panel to carry out a display of the image corresponding to the video image Source, and (ii) the second liquid crystal panel to carry out a display so that the second liquid crystal panel entirely becomes a light transmittance state, in accordance with the video image source.

6. The liquid crystal display device according to claim 2, wherein the display signal generating means generates display signals that cause said at least two liquid crystal panels to display images that are different for every dot so that the image corresponding to the video image source is displayed by said at least two liquid crystal panels which are combined with one another.

7. The liquid crystal display device according to claim 2, wherein the display signal generating means generates display signals that cause said at least two liquid crystal panels to display images that are different for every source line so that the image corresponding to the video image source is displayed by said at least two liquid crystal panels which are combined with one another.

8. The liquid crystal display device according to claim 2, wherein the display signal generating means generates display signals that cause said at least two liquid crystal panels to display images that are different for every gate line so that the image corresponding to the video image source is displayed by said at least two liquid crystal panels which are combined with one another.

9. The liquid crystal display device according to claim 2, further comprising a timer for measuring time,
the preset period of time being a period of time measured by the timer.

10. The liquid crystal display device according to claim 2, wherein the preset interval is a frame period of said at least two liquid crystal panels.

11. The liquid crystal display device according to claim 2, wherein polarizing absorption layers, by which said at least two liquid crystal panels are sandwiched, respectively, are provided so that crossed Nichol relations are formed.

12. The liquid crystal display device according to claim 2, wherein
two polarizing absorption layers are provided on an uppermost surface and on a lowermost surface of said at least two liquid crystal panels, respectively, which are combined with one another, and
polarizing axes of the polarizing absorption layers are set so that the polarizing absorption layers form a crossed Nichol relation.

13. An electronic device comprising a liquid crystal display device,
said liquid crystal display panel in which at least two liquid crystal panels, which are combined with one another, display respective images which vary in accordance with a video image source so that an image corresponding to the video image source is displayed by said at least two liquid crystal panels,
said liquid crystal display device comprising:
display signal generating means for generating display signals causing said at least two liquid crystal panels to display the respective images that are different from one another in accordance with the video image source; and
display signal outputting means for switching the display signals, generated by the display signal generating means, with one another for every preset period of time, and for outputting the display signals thus switched to said at least two liquid crystal panels, respectively.

14. The liquid crystal display device according to claim 3, wherein the display signal generating means generates display signals that cause said at least two liquid crystal panels to display images that are different for every dot so that the image corresponding to the video image source is displayed by said at least two liquid crystal panels which are combined with one another.

15. The liquid crystal display device according to claim 3, wherein the display signal generating means generates display signals that cause said at least two liquid crystal panels to display images that are different for every source line so that the image corresponding to the video image source is displayed by said at least two liquid crystal panels which are combined with one another.

16. The liquid crystal display device according to claim 3, wherein the display signal generating means generates display signals that cause said at least two liquid crystal panels to display images that are different for every gate line so that the image corresponding to the video image source is displayed by said at least two liquid crystal panels which are combined with one another.

17. The liquid crystal display device according to claim 3, further comprising a timer for measuring time,
the preset period of time being a period of time measured by the timer.

18. The liquid crystal display device according to claim 3, wherein the preset interval is a frame period of said at least two liquid crystal panels.

19. The liquid crystal display device according to claim 3, wherein polarizing absorption layers, by which said at least two liquid crystal panels are sandwiched, respectively, are provided so that crossed Nichol relations are formed.

20. The liquid crystal display device according to claim 3, wherein
two polarizing absorption layers are provided on an uppermost surface and on a lowermost surface of said at least two liquid crystal panels, respectively, which are combined with one another, and
polarizing axes of the polarizing absorption layers are set so that the polarizing absorption layers form a crossed Nichol relation.
